(19) United States
(12) Patent Application Publication
(10) Pub. No.: US 2015/0046244 A1
(43) Pub. Date: Feb. 12, 2015

(54) Server, Computer Readable Storage Medium, Computer Implemented Method and Mobile Computing Device for Discounting Payment Transactions, Facilitating Discounting Using Augmented Reality and Promotional Offering Using Augmented Reality

(71) Applicant: Fairweather Corporation Pty Ltd., New South Wales (AU)

(72) Inventor: Christopher John Baxter, New South Wales (AU)

(21) Appl. No.: 14/507,881

(22) Filed: Oct. 7, 2014

Related U.S. Application Data
(63) Continuation of application No. PCT/AU2013/000108, filed on Feb. 7, 2013.

(30) Foreign Application Priority Data
Feb. 8, 2012 (AU) 2012900462
Feb. 21, 2012 (AU) 2012900646
Feb. 21, 2012 (AU) 2012900649
May 24, 2012 (AU) 2012902144
Jun. 15, 2012 (AU) 2012902502

(51) Int. Cl. G06Q 30/02; G06T 19/00

(52) U.S. Cl. CPC G06Q 30/0222; G06T 19/006
USPC 705/14.23

(57) ABSTRACT

A mobile computing device for facilitating discounting using augmented reality includes a processor structured to process digital data and to execute computer program code, a memory device coupled to the processor and storing the digital data including the computer program code, a video capture interface coupled to the processor and capturing video scene data, and a display device coupled to the processor and displaying the video scene data. The processor is controlled by the computer program code to receive, via the video capture interface, the video scene data, display, using the display device, the video scene data, determine an occurrence of a discount event, and display, using the display device, a discount related overlay in accordance with the occurrence of the discount event.

### CROSS-REFERENCE TO RELATED APPLICATIONS

This is a continuing application under 35 U.S.C. §120 of copending International Application No. PCT/AU2013/000108, filed on Feb. 7, 2013, which designated the United States and was published in English; this application also claims the priority under 35 U.S.C. §119, of Australian patent application Nos. 2012900462, filed on Feb. 8, 2012, 2012900649 filed on Feb. 21, 2012, 2012900646, filed on Feb. 21, 2012, 2012902144 filed on May 24, 2012, and 2012902502 filed on Jun. 15, 2012; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present invention relates to a server, a computer readable storage medium, a computer implemented method and a mobile computing device for discounting payment transactions, facilitating discounting using augmented reality and promotional offering using augmented reality.

The invention has been developed primarily for use with payment processing and will be described hereinafter with reference to this application. However, it will be appreciated that the invention is not limited to this particular field of use.

### BACKGROUND OF THE INVENTION

Vendors today employ various measures for attracting shoppers to spend at the vendor's store. Once such measure comprises offering discounting of payment transactions to entice shoppers.

However, such measures suffer from various disadvantages. Firstly, shoppers are often unaware of the provision of a discount to other shoppers, and, even in the case where such shoppers are aware of such discounts, such shoppers may not trust the other shopper's shopping habits, especially on account of the other shoppers being unknown to such shoppers. Furthermore, shoppers generally do not advertise or endorse vendors, resulting in vendors having to embark on advertising campaigns and the like. Also, for those shoppers that do endorse a vendor, the vendor has no way to reward the shopper or for keeping track of such endorsements.

Billions are spent each year on advertising by vendors looking to attract customers by way of television, radio, print media and the like. However, these traditional advertising are outmoded and have failed to take advantage in the recent advances of processing power of computing devices, such as mobile computing devices like mobile phones, tablets and the like.

It is to be understood that, if any prior art information is referred to herein, such reference does not constitute an admission that the information forms part of the common general knowledge in the art, in Australia or any other country.

Thus, a need exists to overcome the problems with the prior art systems, designs, and processes as discussed above.

### SUMMARY OF THE INVENTION

The invention provides a server, a computer readable storage medium, a computer implemented method and a mobile computing device for discounting payment transactions, facilitating discounting using augmented reality and promotional offering using augmented reality that overcome the hereinafore-mentioned disadvantages of the heretofore-known devices and methods of this general type.

According to one aspect, there is provided a server for discounting payment transactions comprising: a processor for processing digital data, a memory device for storing digital data including computer program code and being coupled to the processor, and a network interface for sending and receiving digital data and being coupled to the processor, wherein the processor is controlled by the computer program code to: receive, via the network interface, payment transaction request data representing a payment transaction request, calculate discount data representing a discount in accordance with social graph data corresponding to the payment transaction request data.

Advantageously, the server is adapted for calculating relationships using social graph data in discounting processing payments so as to reward purchasers in such relationships. In this manner, purchasers are encouraged to amend their social graph data, such as for example by creating a connection with a vendor, so as to receive a discount when purchasing from the vendor. Furthermore, the server is adapted for various applications, such as by interfacing with point-of-sale (POS) terminals, e-commerce platforms and the like in the calculation of discounts in accordance with social graph data.

Preferably, the processor is controlled by the computer program code to calculate the discount data further in accordance with the payment transaction request data.

Preferably, the server further comprises a database for storing digital data comprising the social graph data representing a social graph wherein the database is coupled to the processor.

Preferably, the processor is controlled by the computer program code to receive, via the network interface, the social graph data.

Preferably the processor is controlled by the computer program code to receive, via the network interface, social credential data, and authenticate with the social platform in accordance with the social credential data.

Advantageously, the social graph data may be retrieved from a third party social platform using an API (application programming interface).

Preferably, the processor is further controlled by the computer program code to process a payment transaction.

Preferably, in calculating the discount data, the processor is further controlled by the computer program code to: identify a purchaser in accordance with the payment transaction request data, identify a vendor in accordance with the payment transaction request data, identify a relationship between the purchaser and the vendor in accordance with the social graph data, and calculate the discount data further in accordance with the relationship.

Preferably, the relationship is an endorsement.

Advantageously, the server is adapted for identifying a particular type of relationship between the vendor and the purchaser so as to be able to reward such relationship. Once such relationship is an endorsement, wherein the social graph data indicates that the purchaser has endorsed the vendor.

Preferably, in calculating the discount data, the processor is further controlled by the computer program code to calculate a shortest relationship path between the purchaser and the vendor in accordance with the social graph data, and to calculate the discount data further in accordance with the shortest relationship path.

Preferably, in calculating the discount data, the processor is further controlled by the computer program code to calculate the discount data further in accordance with the length of the shortest relationship path.

Advantageously, the server is adapted to utilize a shortest relationship path algorithm to calculate the closest relationship between the purchaser and the vendor. In this manner, a discount can be calculated in accordance with the degree of relationship wherein, for example, for an n^{th} degree relationship a larger discount is calculated for a low n value as compared to a higher n value.

Preferably, the processor is further controlled by the computer program code to identify a purchaser in accordance with the payment transaction request data, identify a vendor in accordance with the payment transaction request data, and update the social graph data to establish a relationship between the purchaser and the vendor.

Advantageously, the server is adapted to update the social graph data, such as by creating a relationship between the vendor and the purchaser, in anticipation of calculating the discount.

Preferably, the processor is further controlled by the computer program code to identify a purchaser in accordance with the payment transaction request data, identify a vendor in accordance with the payment transaction request data, and update the social graph data to modify a relationship between the purchaser and the vendor.

Preferably, the processor is further controlled by the computer program code to identify a purchaser in accordance with the payment transaction request data, identify a vendor in accordance with the payment transaction request data, and send, via the network interface, notification representing a feed notification associated with the purchaser.

Advantageously, the server is adapted to update the social graph data to publish information regarding the granting of the discount. In this manner, other purchasers of the social graph are made aware of the discount.

Preferably, the processor is further controlled by the computer program code to identify a purchaser in accordance with the payment transaction request data, wherein the social graph data is associated with the purchaser, identify a vendor in accordance with the payment transaction request data, and update the social graph data with notification data representing a notification associated with the purchase.

Preferably, the notification data comprises at least an identity of the vendor.

Preferably, the notification data comprises at least the discount data.

Preferably, the notification data comprises at least the discount data represented as a percentage.

Preferably, the notification data comprises a sale value.

Preferably, in calculating the discount data, the processor is further controlled by the computer program code to calculate a price in accordance with the payment transaction request data and calculate the discount data further in accordance with the price.

Preferably, in calculating the discount data, the processor is further controlled by the computer program code to identify a purchaser in accordance with the payment transaction request data, count a number of social connections of the purchaser in accordance with the social graph data, and calculate the discount data further in accordance with the number of social connections.

Preferably, in calculating the discount data, the processor is further controlled by the computer program code to identify a purchaser in accordance with the payment transaction request data, count a number of posts associated with the purchaser in accordance with the social graph data, and calculate the discount data further in accordance with the number of posts.

Preferably, in calculating the discount data, the processor is further controlled by the computer program code to identify a vendor in accordance with the payment transaction request data, count a number of posts associated with the vendor in accordance with the social graph data, and calculate the discount data further in accordance with the number of posts.

Preferably, in calculating the discount data, the processor is further controlled by the computer program code to identify a vendor in accordance with the payment transaction request data and calculate the discount data further in accordance with the vendor.

Preferably, in calculating the discount data, the processor is further controlled by the computer program code to identify a product in accordance with the payment transaction request data and calculate the discount data further in accordance with the product.

Preferably, in calculating the discount data, the processor is further controlled by the computer program code to calculate the discount data further in accordance with a time of day.

Preferably, in calculating the discount data, the processor is further controlled by the computer program code to identify a payment instrument in accordance with the payment transaction request data and calculate the discount data further in accordance with the payment instrument.

Advantageously, the server is adapted for generating a variable discount value, based on various metrics.

Preferably, the processor is further controlled by the computer program code to send, via the network interface, notification data representing a notification to a mobile device.

Preferably, the notification is a push notification.

Preferably, the processor is further controlled by the computer program code to receive, via the network interface, response data representing a response to the notification and process, via the network interface, a payment transaction in accordance with the discount upon receipt of the response data.

Preferably, the processor is further controlled by the computer program code to receive, via the network interface, response data representing a response to the notification and send, via the network interface, notification data representing a feed notification associated with the purchaser.

Preferably, the processor is further controlled by the computer program code to receive, via the network interface, response data representing a response to the notification identify a purchaser in accordance with the payment transaction request data, wherein the social graph data is associated with the purchaser, and update the social graph data with notification data representing a feed notification associated with the purchase.

Preferably, the notification data comprises a name of a vendor.

Preferably, the notification data comprises a name of a product.

Preferably, the notification data comprises the discount.

Advantageously, the purchaser is able to use the mobile device to confirm acceptance of the discount, allow updating of their social graph data, receive a verification code for redeeming the discount and the like.

According to one aspect, there is provided a server for calculating a social discount, the server comprising a processor for processing digital data, a memory device for storing digital data including computer program code and being coupled to the processor, and a network interface for sending and receiving digital data and being coupled to the processor, wherein the processor is controlled by the computer program code to receive, via the network interface, social discount request data representing a request to calculate a social discount, and calculate discount data representing a discount in accordance with social graph data corresponding to the social discount request data.

According to one aspect, there is provided a client computing device comprising a network interface for sending and receiving digital data and being coupled, across a data network, to a server as described herein, wherein the network interface is adapted for sending and receiving data as described herein.

According to another aspect, there is provided a computer readable storage medium for discounting payment transactions, the computer readable storage medium having computer program code instructions recorded thereon, the computer program code instructions being executable by a computer and comprising instructions for receiving, via a network interface, payment transaction request data representing a payment transaction request, and calculating discount data representing a discount in accordance with social graph data corresponding to the payment transaction request data.

Preferably, the computer readable storage medium further comprises instructions for calculating the discount data further in accordance with the payment transaction request data.

Preferably, the computer readable storage medium further comprises instructions for retrieving the social graph data from a database.

Preferably, the computer readable storage medium further comprises instructions for receiving, via the network interface, the social graph data.

Preferably, the computer readable storage medium further comprises receiving, via the network interface, social credential data and authenticating with the social platform in accordance with the social credential data.

Preferably, the computer readable storage medium further comprises instructions for process a payment transaction.

Preferably, the computer readable storage medium further comprises instructions for identifying a purchaser in accordance with the payment transaction request data, identifying a vendor in accordance with the payment transaction request data, identifying a relationship between the purchaser and the vendor in accordance with the social graph data, and calculating the discount data further in accordance with the relationship.

Preferably, the relationship is an endorsement.

Preferably, the computer readable storage medium further comprises instructions for calculating a shortest relationship path between the purchaser and the vendor in accordance with the social graph data and calculating the discount data further in accordance with the shortest relationship path.

Preferably, the computer readable storage medium further comprises instructions for calculating the discount data further in accordance with the length of the shortest relationship path.

Preferably, the computer readable storage medium further comprises instructions for identifying a purchaser in accordance with the payment transaction request data, identifying a vendor in accordance with the payment transaction request data, and updating the social graph data to establish a relationship between the purchaser and the vendor.

Preferably, the computer readable storage medium further comprises instructions for identifying a purchaser in accordance with the payment transaction request data, identifying a vendor in accordance with the payment transaction request data, and updating the social graph data to modify a relationship between the purchaser and the vendor.

Preferably, the computer readable storage medium further comprises instructions for identifying a purchaser in accordance with the payment transaction request data, identifying a vendor in accordance with the payment transaction request data, and sending, via the network interface, notification representing a feed notification associated with the purchaser.

Preferably, the computer readable storage medium further comprises instructions for identifying a purchaser in accordance with the payment transaction request data, wherein the social graph data is associated with the purchaser, identifying a vendor in accordance with the payment transaction request data, and updating the social graph data with notification data representing a notification associated with the purchase.

Preferably, the notification data comprises at least an identity of the vendor.

Preferably, the notification data comprises at least the discount data.

Preferably, the notification data comprises at least the discount data represented as a percentage.

Preferably, the notification data comprises a sale value.

Preferably, the computer readable storage medium further comprises instructions for calculating a price in accordance with the payment transaction request data and calculating the discount data further in accordance with the price.

Preferably, the computer readable storage medium further comprises instructions for identifying a purchaser in accordance with the payment transaction request data, counting a number of social connections of the purchaser in accordance with the social graph data, and calculating the discount data further in accordance with the number of social connections.

Preferably, the computer readable storage medium further comprises instructions for identifying a purchaser in accordance with the payment transaction request data, counting a number of posts associated with the purchaser in accordance with the social graph data, and calculating the discount data further in accordance with the number of posts.

Preferably, the computer readable storage medium further comprises instructions for identifying a vendor in accordance with the payment transaction request data, counting a number of posts associated with the vendor in accordance with the social graph data, and calculating the discount data further in accordance with the number of posts.

Preferably, the computer readable storage medium further comprises instructions for identifying a vendor in accordance with the payment transaction request data and calculating the discount data further in accordance with the vendor.

Preferably, the computer readable storage medium further comprises instructions for identifying a product in accordance with the payment transaction request data and calculating the discount data further in accordance with the product.

Preferably, the computer readable storage medium further comprises instructions for calculating the discount data further in accordance with a time of day.

Preferably, the computer readable storage medium further comprises instructions for identifying a payment instrument in accordance with the payment transaction request data and calculating the discount data further in accordance with the payment instrument.

Preferably, the computer readable storage medium further comprises instructions for sending, via the network interface, notification data representing a notification to a mobile device.

Preferably, the notification is a push notification.

Preferably, the computer readable storage medium further comprises instructions for receiving, via the network interface, response data representing a response to the notification and processing, via the network interface, a payment transaction in accordance with the discount upon receipt of the response data.

Preferably, the computer readable storage medium further comprises instructions for receiving, via the network interface, response data representing a response to the notification and sending, via the network interface, notification data representing a feed notification associated with the purchaser.

Preferably, the computer readable storage medium further comprises instructions for receiving, via the network interface, response data representing a response to the notification, identifying a purchaser in accordance with the payment transaction request data, wherein the social graph data is associated with the purchaser, and updating the social graph data with notification data representing a feed notification associated with the purchase.

Preferably, the notification data comprises a name of a vendor.

Preferably, the notification data comprises a name of a product.

Preferably, the notification data comprises the discount.

According to another aspect, there is provided a computer readable storage medium for calculating a social discount, the computer readable storage medium comprising instructions for receiving, via the network interface, social discount request data representing a request to calculate a social discount, and calculating discount data representing a discount in accordance with social graph data corresponding to the social discount request data.

According to another aspect, there is provided a computer implemented method for discounting payment transactions, the method comprising receiving, via a network interface, payment transaction request data representing a payment transaction request and calculating discount data representing a discount in accordance with social graph data corresponding to the payment transaction request data.

Preferably, the computer implemented method further comprises calculating the discount data further in accordance with the payment transaction request data.

Preferably, the computer implemented method further comprises retrieving the social graph data from a database.

Preferably, the computer implemented method further comprises receiving, via the network interface, the social graph data.

Preferably, the computer implemented method further comprises receiving, via the network interface, social credential data and authenticating with the social platform in accordance with the social credential data.

Preferably, the computer implemented method further comprises processing a payment transaction.

Preferably, the computer implemented method further comprises identifying a purchaser in accordance with the payment transaction request data, identifying a vendor in accordance with the payment transaction request data, identifying a relationship between the purchaser and the vendor in accordance with the social graph data, and calculating the discount data further in accordance with the relationship.

Preferably, the relationship is an endorsement.

Preferably, the computer implemented method further comprises calculating a shortest relationship path between the purchaser and the vendor in accordance with the social graph data and calculating the discount data further in accordance with the shortest relationship path.

Preferably, the computer implemented method further comprises calculating the discount data further in accordance with the length of the shortest relationship path.

Preferably, the computer implemented method further comprises identifying a purchaser in accordance with the payment transaction request data, identifying a vendor in accordance with the payment transaction request data, and updating the social graph data to establish a relationship between the purchaser and the vendor.

Preferably, the computer implemented method further comprises identifying a purchaser in accordance with the payment transaction request data, identifying a vendor in accordance with the payment transaction request data, and updating the social graph data to modify a relationship between the purchaser and the vendor.

Preferably, the computer implemented method further comprises identifying a purchaser in accordance with the payment transaction request data, identifying a vendor in accordance with the payment transaction request data, and sending, via the network interface, notification representing a feed notification associated with the purchaser.

Preferably, the computer implemented method further comprises identifying a purchaser in accordance with the payment transaction request data, wherein the social graph data is associated with the purchaser, identifying a vendor in accordance with the payment transaction request data, and updating the social graph data with notification data representing a notification associated with the purchase.

Preferably, the notification data comprises at least an identity of the vendor.

Preferably, the notification data comprises at least the discount data.

Preferably, the notification data comprises at least the discount data represented as a percentage.

Preferably, the notification data comprises a sale value.

Preferably, the computer implemented method further comprises calculating a price in accordance with the payment transaction request data and calculating the discount data further in accordance with the price.

Preferably, the computer implemented method further comprises identifying a purchaser in accordance with the payment transaction request data, counting a number of social connections of the purchaser in accordance with the social graph data, and calculating the discount data further in accordance with the number of social connections.

Preferably, the computer implemented method further comprises identifying a purchaser in accordance with the payment transaction request data, counting a number of posts associated with the purchaser in accordance with the social graph data, and calculating the discount data further in accordance with the number of posts.

Preferably, the computer implemented method further comprises identifying a vendor in accordance with the payment transaction request data, counting a number of posts associated with the vendor in accordance with the social graph data, and calculating the discount data further in accordance with the number of posts.

Preferably, the computer implemented method further comprises identifying a vendor in accordance with the payment transaction request data and calculating the discount data further in accordance with the vendor.

Preferably, the computer implemented method further comprises identifying a product in accordance with the payment transaction request data and calculating the discount data further in accordance with the product.

Preferably, the computer implemented method further comprises calculating the discount data further in accordance with a time of day.

Preferably, the computer implemented method further comprises identifying a payment instrument in accordance with the payment transaction request data and calculating the discount data further in accordance with the payment instrument.

Preferably, the computer implemented method further comprises sending, via the network interface, notification data representing a notification to a mobile device.

Preferably, the notification is a push notification.

Preferably, computer implemented method further comprises receiving, via the network interface, response data representing a response to the notification and processing, via the network interface, a payment transaction in accordance with the discount upon receipt of the response data.

Preferably, the computer implemented method further comprises receiving, via the network interface, response data representing a response to the notification and sending, via the network interface, notification data representing a feed notification associated with the purchaser.

Preferably, the computer implemented method further comprises receiving, via the network interface, response data representing a response to the notification, identifying a purchaser in accordance with the payment transaction request data, wherein the social graph data is associated with the purchaser, and updating the social graph data with notification data representing a feed notification associated with the purchase.

Preferably, the notification data comprises a name of a vendor.

Preferably, the notification data comprises a name of a product.

Preferably, the notification data comprises the discount.

According to another aspect, there is provided a computer implemented method for calculating a social discount, the computer implemented method comprising receiving, via the network interface, social discount request data representing a request to calculate a social discount and calculating discount data representing a discount in accordance with social graph data corresponding to the social discount request data.

It should be noted that the web server, client computing device and the computer readable storage medium provide the same or similar advantages as the advantages provided by the corresponding computer implemented method, some of which are described herein. Additionally the web server and/or client computing device provides the advantage of deployment across a computer network, such as the Internet, providing distribution, access and economy of scale advantages. Furthermore, the computer readable storage medium provides further advantages, such allowing the deployment of computer instructions for installation and execution by one or more computing devices.

According to one aspect, there is provided a mobile computing device for facilitating discounting using augmented reality, the mobile computing device comprising a processor for processing digital data. a memory device for storing digital data including computer program code and being coupled to the processor; a video capture interface for capturing video scene data and being coupled to the processor, a display device for displaying the video scene data and being coupled to the processor, wherein the processor is controlled by the computer program code to receive, via the video capture interface, the video scene data, display, using the display device, the video scene data, calculate the occurrence of a discount event, and display, using the display device, a discount related overlay in accordance with the occurrence of the discount event.

Advantageously, the mobile computing device is adapted to facilitate the provision of augmented reality discounting. The mobile computing device is adapted for capturing and displaying video data, wherein the mobile computing device overlays a discount over the video data. In this manner, a shopper can walk through a shopping district, holding the mobile computing device at eye level to view the captured video data. Where the mobile computing device detects the occurrence of a discount event, the mobile computing device may display a discount over the video data, allowing vendors to attract customers.

Preferably, in calculating the occurrence of the discount event, the processor is controlled by the computer program code to calculate the occurrence of the discount event using an image recognition algorithm having as input the video scene data.

Advantageously, the mobile computing device is adapted to recognize items such as products from video scene data.

Preferably, the image recognition algorithm comprises a color recognition technique.

Advantageously, the image recognition algorithm is a simple algorithm requiring little processing power and therefore being suited for less powerful mobile computing devices.

Preferably, the image recognition algorithm comprises a shape recognition technique.

Preferably, the image recognition algorithm comprises a barcode recognition technique.

Preferably, the image recognition algorithm is adapted to identify a product.

Advantageously, the mobile computing device is adapted to determine a discount related to the product.

Preferably, the image recognition algorithm is adapted to identify a store.

Advantageously, the mobile computing device is adapted to calculate one or more discounts offered by the store.

Preferably, the mobile computing device further comprises a location sensor sensing location data and being coupled to the processor, wherein, in calculating the occurrence of the discount event, the processor is controlled by the computer program code to calculate the occurrence of the discount event in accordance with the location data.

Advantageously, the location sensor is used by the mobile computing device in augmenting the identification of a product or a store.

Preferably, the mobile computing device further comprises an orientation sensor for sensing orientation data and being coupled to the processor, wherein in calculating the occurrence of the discount event, the processor is controlled by the computer program code to calculate the occurrence of the discount event in accordance with the orientation data.

Advantageously, the orientation data is used by the mobile computing device in augmenting the identification of a product or a store.

Preferably, the processor is controlled by the computer program code to calculate a display location of the discount related item in accordance with the orientation data.

Preferably, the discount related overlay comprises an avatar.

Preferably, the discount related overlay comprises a redeemable token.

Preferably, the processor is controlled by the computer program code to calculate discount data in accordance with the discount event.

Preferably, the discount related overlay comprises the discount data.

Preferably, the processor is controlled by the computer program code to calculate the discount data in accordance with a social graph.

Advantageously, the mobile computing device is adapted to take into account social graph data, such as social graph data associated with the user of the mobile computing device so as to be able to reward certain social relations in calculating discount data.

Preferably, the processor is controlled by the computer program code to calculate the occurrence of a discount event in accordance with a social graph.

According to another aspect, there is provided a computer readable storage medium for facilitating discounting using augmented reality, the computer readable storage medium having computer program code instructions recorded thereon, the computer program code instructions being executable by a computer and comprising instructions for receiving, via a video capture interface, video scene data, displaying, using a displaying device, the video scene data, calculating the occurrence of a discount event, displaying, using the displaying device, a discount related overlay in accordance with the occurrence of the discount event.

Preferably, the computer readable storage medium further comprises instructions for calculating the occurrence of the discount event using an image recognition algorithm having as input the video scene data. Preferably, the image recognition algorithm comprises a color recognition technique.

Preferably, the image recognition algorithm comprises a shape recognition technique.

Preferably, the image recognition algorithm comprises a barcode recognition technique.

Preferably, the image recognition algorithm is adapted to identify a product.

Preferably, the image recognition algorithm is adapted to identify a store.

Preferably, the computer readable storage medium further comprises instructions for calculating the occurrence of the discount event in accordance with location data.

Preferably, the computer readable storage medium further comprises instructions for calculating the occurrence of the discount event in accordance with orientation data.

Preferably, the computer readable storage medium further comprises instructions for calculating a display location of the discount related item in accordance with the orientation data.

Preferably, the discount related overlay comprises an avatar.

Preferably, the discount related overlay comprises a redeemable token.

Preferably, the computer readable storage medium further comprises instructions for calculating discount data in accordance with the discount event.

Preferably, the discount related overlay comprises the discount data.

Preferably, the computer readable storage medium further comprises instructions for calculating the discount data in accordance with a social graph.

Preferably, the computer readable storage medium further comprises instructions for calculating the occurrence of a discount event in accordance with a social graph.

According to another aspect, there is provided a computer implemented method for facilitating discounting using augmented reality comprising receiving, via a video capture interface, video scene data, displaying, using a displaying device, the video scene data, calculating the occurrence of a discount event, displaying, using the displaying device, a discount related overlay in accordance with the occurrence of the discount event.

Preferably, the computer implemented method further comprises calculating the occurrence of the discount event using an image recognition algorithm having as input the video scene data.

Preferably, the image recognition algorithm comprises a color recognition technique.

Preferably, the image recognition algorithm comprises a shape recognition technique.

Preferably, the image recognition algorithm comprises a barcode recognition technique.

Preferably, the image recognition algorithm is adapted to identify a product.

Preferably, the image recognition algorithm is adapted to identify a store.

Preferably, the computer implemented method further comprises calculating the occurrence of the discount event in accordance with location data.

Preferably, the computer implemented method further comprises calculating the occurrence of the discount event in accordance with orientation data.

Preferably, the computer implemented method further comprises calculating a display location of the discount related item in accordance with the orientation data.

Preferably, the discount related overlay comprises an avatar.

Preferably, the discount related overlay comprises a redeemable token.

Preferably, the computer implemented method further comprises calculating discount data in accordance with the discount event.

Preferably, the discount related overlay comprises the discount data.

Preferably, the computer implemented method further comprises calculating the discount data in accordance with a social graph.

Preferably, the computer implemented method further comprises calculating the occurrence of a discount event in accordance with a social graph.

According to another aspect, there is provided a mobile computing device for promotional offering using augmented reality, the mobile computing device comprising a processor for processing digital data; a memory device for storing digital data including computer program code and being coupled to the processor, a video capture interface for capturing video scene data and being coupled to the processor, a display device for displaying the video scene data and being coupled to the processor, wherein the processor is controlled by the computer program code to receive, via the video capture interface, the video scene data, display, using the display device, the video scene data, identify a promotional offering event, display, using the display device, an indicia representing the promotional offering event over the video scene data.

Preferably, the processor is controlled by the computer program code to display, using the display device, a virtual structure wherein the virtual structure comprises the indicia.

Preferably, the virtual structure comprises a wall.

Preferably, the promotional offering is a discount offering.

Preferably, the mobile computing device further comprises a network interface for sending and receiving network data and being coupled to the processor, and wherein the processor is further controlled by the computer program code to receive, via the network interface, indicia data representing the indicia.

Advantageously, the mobile computing device is adapted to facilitate the provision of augmented reality discounting. The mobile computing device is adapted for capturing and displaying video data, wherein the mobile computing device overlays a discount over the video data. In this manner, a shopper can walk through a shopping district, holding the mobile computing device at eye level to view the captured video data. Where the mobile computing device detects the occurrence of a discount event, the mobile computing device may display a discount over the video data, allowing vendors to attract customers.

Preferably, the processor is further controlled by the computer program code to identify the promotional offering event in accordance with the video scene data.

Advantageously, the mobile computing device is adapted to be able to recognize scenes and objects in determining when the discount event occurs.

Preferably, in identifying the promotional offering event, the processor is further controlled by the computer program code to identify a merchant.

Preferably, the processor is further controlled by the computer program code to display, using the display device, ancillary information data representing ancillary information relating to the merchant.

Advantageously, the mobile computing device is adapted to allow the user to view further information about the merchant before deciding to engage with the merchant.

Preferably, the ancillary information comprises at least one other user who has previously interacted with the merchant.

Preferably, the interaction is an endorsement on a social network.

Preferably, the ancillary information further comprises an image associated with the at least one other user.

Preferably, the mobile computing device further comprises a user input interface for receiving user input data and being coupled to the processor, and wherein the processor is further controlled by the computer program code to receive, via the user input interface, user selection data representing the user selection of the indicia.

Preferably, the indicia represents an endorsement.

Preferably, the processor is controlled by the computer program code to display, using the display device, a different indicia after receipt of the user selection data.

Preferably, the processor is controlled by the computer program code to display, using the display device, a different indicia after receipt of the user selection data.

Advantageously, the mobile computing device is adapted to allow users to endorse store or merchants so as to be able to receive rewards, discounts and the like in return.

Preferably, the mobile computing device further comprises a network interface for sending and receiving network data and being coupled to the processor, and wherein the processor is further controlled by the computer program code to send, via the network interface, social graph update data in accordance with the user selection data.

Preferably, the processor is further controlled by the computer program code to receive, via the user input interface, social network authentication credentials.

Preferably, the social graph update data relates to a social network.

Preferably, the social graph update data relates to a social network of a merchant.

Advantageously, the mobile computing device is adapted to update the social graph data of the user using a third party social platform.

Preferably, the social graph update data comprises endorsement data representing an endorsement of a merchant on a user's social network account.

Preferably, the social graph update data comprises data for an endorsement of the merchant on a user's social network account.

Preferably, the processor, upon receipt of the user selection data, is further controlled by the computer program code to display, using the display device, promotion data comprising at least one product or service.

Preferably, the processor is further controlled by the computer program code to select the at least one product or service in accordance with profile data of a user.

Preferably, the profile data comprises body proportion data representing at least one body proportion of the user.

Preferably, the at least one product or service relates to two or more products or services of a merchant.

Preferably, the promotion data comprises at least a discount amount associated with the at least one product or service.

Advantageously, the processor is further controlled by the computer program code to display, using the display device, the discount amount associated with the at least one product or service as a percentage of a cost price of the at least one product or service.

Advantageously, the mobile computing device is adapted to offer a discount to the user as reward for the user having endorsed the merchant so.

Preferably, the processor is further controlled by the computer program code to calculate the discount amount in accordance with a number of users.

Preferably, the processor is further controlled by the computer program code to calculate the discount amount in accordance with a time period.

Preferably, the mobile computing device further comprises a user input interface for receiving user input data and being coupled to the processor, and wherein the processor is further controlled by the computer program code to receive, via the user input interface, user selection data representing the user selection of the at least one product or service.

Preferably, the user input interface is a voice transducer adapted for recognizing voice commands of the user.

Preferably, the user input interface is a gesture transducer adapted for recognizing gestures of the user.

Preferably, the processor is further controlled by the computer program code to display, using the display device, the first amount associated with the at least one product or service and display, using the display device, the discount amount associated with the at least one product or service.

Preferably, the discount amount is calculated in accordance with social graph data.

Preferably, the discount amount is calculated in accordance with the number of social connections of a social network user.

Preferably, the discount amount is calculated in accordance with influence of a social network user.

Preferably, the discount amount is calculated in accordance with the activity of a social network user.

Preferably, the discount amount is calculated in accordance with the cost price of a product or service.

Preferably, the discount amount is calculated in accordance with the retail price of a product or service.

Preferably, the discount amount is calculated in accordance with sale price of a product or service.

Preferably, the discount amount is calculated in accordance with discount limitations of a product.

Preferably, the discount amount is calculated in accordance with discount limitations of a store.

Preferably, processor is further controlled by the computer program code to display, using the display device, an electronic discount coupon.

Preferably, the mobile computing device further comprises a user input interface for receiving user input data and being coupled to the processor, and the processor is further controlled by the computer program code to receive, via the user input interface, user selection data representing an instruction to initiate an e-commerce transaction and facilitate an e-commerce transaction in accordance with the discount amount.

Preferably, the indicia comprises an avatar.

Preferably, the mobile computing device further comprises a location sensor sensing location data and being coupled to the processor, wherein, in displaying the indicia over the video scene data, the processor is further controlled by the computer program code to display, using the display device, the indicia over the video scene data in accordance with the location data.

Advantageously, the location sensor is able to narrow down the potentially matching discount related events.

Preferably, the mobile computing device further comprises an orientation sensor sensing orientation data and being coupled to the processor, wherein, in displaying the indicia over the video scene data, the processor is controlled by the computer program code to display, using the display device, the indicia over the video scene data in accordance with the orientation data.

Advantageously, the mobile computing device is adapted to use the orientation data to display the indicia on the correct location of the screen.

According to another aspect, there is provided a computer readable storage medium for promotional offering using augmented reality, the computer readable storage medium having computer program code instructions recorded thereon, the computer program code instructions being executable by a computer and comprising instructions for receiving, via a video capture interface, the video scene data, instructions for displaying, using a display device, the video scene data, instructions for identifying a promotional offering event, instructions for displaying, using the display device, an indicia representing the promotional offering event over the video scene data.

Preferably, the computer readable storage medium further comprises instructions for identifying the promotional offering event in accordance with the video scene data.

Preferably, the computer readable storage medium further comprises instructions for identifying a merchant.

Preferably, the computer readable storage medium further comprises instructions for displaying, using the display device, ancillary information data representing ancillary information relating to the merchant.

Preferably, the ancillary information comprises at least one other user who has previously interacted with the merchant.

Preferably, the ancillary information further comprises an image associated with the at least one other user.

Preferably, the computer readable storage medium further comprises instructions for receiving, via a user input interface, user selection data representing the user selection of the indicia.

Preferably, the indicia represents an endorsement.

Preferably, computer readable storage medium further comprises instructions for displaying, using the display device, a different indicia after receipt of the user selection data.

Preferably, the computer readable storage medium further comprises instructions for displaying a different indicia after receipt of the user selection data.

Preferably, the computer readable storage medium further comprises instructions for sending, via a network interface, social graph update data in accordance with the user selection data.

Preferably, the social graph update data comprises endorsement data representing an endorsement of a merchant on a user's social network account.

Preferably, the social graph update data comprises data for an endorsement of the merchant on a user's social network account.

Preferably, the computer readable storage medium further comprises instructions for displaying, using the display device, promotion data comprising at least one product or service and at least a discount amount associated with the at least one product or service.

Preferably, the discount amount is calculated in accordance with social graph data.

Preferably, the discount amount is calculated in accordance with the number of social connections of a social network user.

Preferably, the discount amount is calculated in accordance with influence of a social network user.

Preferably, the discount amount is calculated in accordance with the activity of a social network user.

Preferably, the discount amount is calculated in accordance with the cost price of a product or service.

Preferably, the discount amount is calculated in accordance with the retail price of a product or service.

Preferably, the discount amount is calculated in accordance with sale price of a product or service.

Preferably, the discount amount is calculated in accordance with discount limitations of a product.

Preferably, the discount amount is calculated in accordance with discount limitations of a store.

Preferably, the computer readable storage medium further comprises instructions for displaying, using the display device, an electronic discount coupon.

Preferably, the electronic discount coupon comprises barcode information.

Preferably, the barcode information comprises two-dimensional barcode information.

Preferably, the mobile computing device further comprises a network interface sending and receiving network data and being coupled to the processor, and wherein the processor is further controlled by the computer program code to send, via the network interface, the electronic discount coupon.

Preferably, the mobile computing device further comprises a near field communication interface for sending near field communication data and being coupled to the processor, and wherein the processor is further controlled by the computer program code to send, via the near field communication interface, the electronic discount coupon.

Preferably, the computer readable storage medium further comprises instructions for receiving user selection data representing an instruction to initiate an e-commerce transaction facilitating an e-commerce transaction in accordance with the discount amount.

Preferably, the mobile computing device further comprises a network interface sending and receiving network data and being coupled to the processor, and wherein the processor is further controlled by the computer program code to send, via the network interface, the user selection data.

Preferably, the indicia comprises an avatar.

Preferably, the computer readable storage medium further comprises instructions for displaying, using the display device, the indicia over the video scene data in accordance with location data.

Preferably, the computer readable storage medium further comprises instructions for displaying, using the display device, the indicia over the video scene data in accordance with orientation data.

According to another aspect, there is provided a computer readable storage medium for promotional offering using augmented reality, the computer readable storage medium having computer program code instructions recorded thereon, the computer program code instructions being executable by a computer and comprising instructions for receiving, via a video capture interface, the video scene data, instructions for displaying, using a display device, the video scene data, instructions for identifying a promotional offering event, instructions for displaying, using the display device, an indicia representing the promotional offering event over the video scene data.

Preferably, the computer readable storage medium further comprises instructions for displaying, using the display device, a virtual structure wherein the virtual structure comprises the indicia.

Preferably, the virtual structure comprises a wall.

Preferably, the promotional offering is a discount offering.

Preferably, the computer readable storage medium further comprises instructions for receiving, via a network interface, indicia data representing the indicia.

Preferably, the computer readable storage medium further comprises instructions for identifying the promotional offering event in accordance with the video scene data.

Preferably, the computer readable storage medium further comprises instructions for identifying a merchant.

Preferably, the computer readable storage medium further comprises instructions for displaying, using the display device, ancillary information data representing ancillary information relating to the merchant.

Preferably, the ancillary information comprises at least one other user who has previously interacted with the merchant.

Preferably, the interaction is an endorsement on a social network.

Preferably, the ancillary information further comprises an image associated with the at least one other user.

Preferably, the computer readable storage medium further comprises instructions for receiving, via a user input interface, user selection data representing the user selection of the indicia.

Preferably, the indicia represents an endorsement.

Preferably, the computer readable storage medium further comprises instructions for displaying a different indicia after receipt of the user selection data.

Preferably, the computer readable storage medium further comprises instructions for sending, via a network interface, social graph update data in accordance with the user selection data.

Preferably, the computer readable storage medium further comprises instructions for receiving, via the user input interface, social network authentication credentials.

Preferably, the social graph update data relates to a social network.

Preferably, the social graph update data relates to a social network of a merchant.

Preferably, the social graph update data comprises data for publishing notification data on a user's social network account.

Preferably, the social graph update data comprises endorsement data representing an endorsement of a merchant on a user's social network account.

Preferably, the computer readable storage medium further comprises instructions for displaying, using the display device, promotion data comprising at least one product or service.

Preferably, the computer readable storage medium further comprises instructions for selecting the at least one product or service in accordance with profile data of a user.

Preferably, the profile data comprises body proportion data representing at least one body proportion of the user.

Preferably, the at least one product or service relates to two or more products or services of a merchant.

Preferably, the promotion data comprises at least a discount amount associated with the at least one product or service.

Preferably, the processor is further controlled by the computer program code to calculate the discount amount in accordance with a number of users.

Preferably, the computer readable storage medium further comprises instructions for calculating the discount amount in accordance with a time period.

Preferably, the computer readable storage medium further comprises instructions for receiving, via a user input interface, user selection data representing the user selection of the at least one product or service.

Preferably, the user input interface is a voice transducer adapted for recognizing voice commands of the user.

Preferably, the user input interface is a gesture transducer adapted for recognizing gestures of the user.

Preferably, the computer readable storage medium further comprises instructions for displaying, using the display device, the first amount associated with the at least one product or service and displaying, using the display device, the discount amount associated with the at least one product or service.

Preferably, the computer readable storage medium further comprises instructions for displaying the discount amount associated with the at least one product or service as a percentage of a cost price of the at least one product or service.

Preferably, the discount amount is calculated in accordance with social graph data.

Preferably, the discount amount is calculated in accordance with the number of social connections of a social network user.

Preferably, the discount amount is calculated in accordance with influence of a social network user.

Preferably, the discount amount is calculated in accordance with the activity of a social network user.

Preferably, the discount amount is calculated in accordance with a cost price of a product or service.

Preferably, the discount amount is calculated in accordance with a retail price of a product or service.

Preferably, the discount amount is calculated in accordance with a sale price of a product or service.

Preferably, the discount amount is calculated in accordance with discount limitations of a product.

Preferably, the discount amount is calculated in accordance with discount limitations of a store.

Preferably, the computer readable storage medium further comprises instructions for displaying an electronic discount coupon.

Preferably, the electronic discount coupon comprises barcode information.

Preferably, the barcode information comprises two-dimensional barcode information.

Preferably, the computer readable storage medium further comprises instructions for sending, via the network interface, the electronic discount coupon.

Preferably, the computer readable storage medium further comprises instructions for sending, via a near field communication interface, the electronic discount coupon.

Preferably, the computer readable storage medium further comprises instructions for receiving user selection data representing an instruction to initiate an e-commerce transaction facilitating an e-commerce transaction in accordance with the discount amount.

Preferably, the computer readable storage medium further comprises instructions for sending, via a network interface, the user selection data.

Preferably, the indicia comprises an avatar.

Preferably, the computer readable storage medium further comprises instructions for displaying, using the display device, the indicia over the video scene data in accordance with location data.

Preferably, the computer readable storage medium further comprises instructions for displaying, using the display device, the indicia over the video scene data in accordance with orientation data.

According to another aspect, there is provided a computer implemented method for promotional offering using augmented reality, the computer implemented method comprising receiving, via a video capture interface, the video scene data, displaying, using a display device, the video scene data, identifying a promotional offering event, displaying, using the display device, an indicia representing the promotional offering event over the video scene data.

Preferably, the computer implemented method further comprises displaying, using the display device, a virtual structure wherein the virtual structure comprises the indicia.

Preferably, the virtual structure comprises a wall.

Preferably, the promotional offering is a discount offering.

Preferably, the computer implemented method further comprises receiving, via a network interface, indicia data representing the indicia.

Preferably, the computer implemented method further comprises identifying the promotional offering event in accordance with the video scene data.

Preferably, the computer implemented method further comprises identifying a merchant.

Preferably, the computer implemented method further comprises displaying, using the display device, ancillary information data representing ancillary information relating to the merchant.

Preferably, the ancillary information comprises at least one other user who has previously interacted with the merchant.

Preferably, the interaction is an endorsement on a social network

Preferably, the ancillary information further comprises an image associated with the at least one other user.

Preferably, the computer implemented method further comprises receiving, via a user input interface, user selection data representing the user selection of the indicia.

Preferably, the indicia represents an endorsement.

Preferably, the computer implemented method further comprises displaying a different indicia after receipt of the user selection data.

Preferably, the computer implemented method further comprises sending, via a network interface, social graph update data in accordance with the user selection data.

Preferably, the computer implemented method further comprises receiving, via the user input interface, social network authentication credentials.

Preferably, the social graph update data relates to a social network.

Preferably, the social graph update data relates to a social network of a merchant.

Preferably, the social graph update data comprises data for publishing notification data on a user's social network account.

Preferably, the social graph update data comprises endorsement data representing an endorsement of a merchant on a user's social network account.

Preferably, the computer implemented method further comprises displaying, using the display device, promotion data comprising at least one product or service.

Preferably, the computer implemented method further comprises selecting the at least one product or service in accordance with profile data of a user.

Preferably, the profile data comprises body proportion data representing at least one body proportion of the user.

Preferably, the at least one product or service relates to two or more products or services of a merchant.

Preferably, the promotion data comprises at least a discount amount associated with the at least one product or service.

Preferably, the processor is further controlled by the computer program code to calculate the discount amount in accordance with a number of users.

Preferably, the computer implemented method further comprises calculating the discount amount in accordance with a time period.

Preferably, the computer implemented method further comprises receiving, via a user input interface, user selection data representing the user selection of the at least one product or service.

Preferably, the user input interface is a voice transducer adapted for recognizing voice commands of the user.

Preferably, the user input interface is a gesture transducer adapted for recognizing gestures of the user.

Preferably, the computer implemented method further comprises displaying, using the display device, the first amount associated with the at least one product or service and displaying, using the display device, the discount amount associated with the at least one product or service.

Preferably, the computer implemented method further comprises displaying the discount amount associated with the at least one product or service as a percentage of a cost price of the at least one product or service.

Preferably, the discount amount is calculated in accordance with social graph data.

Preferably, the discount amount is calculated in accordance with the number of social connections of a social network user.

Preferably, the discount amount is calculated in accordance with influence of a social network user.

Preferably, the discount amount is calculated in accordance with the activity of a social network user.

Preferably, the discount amount is calculated in accordance with a cost price of a product or service.

Preferably, the discount amount is calculated in accordance with a retail price of a product or service.

Preferably, the discount amount is calculated in accordance with a sale price of a product or service.

Preferably, the discount amount is calculated in accordance with discount limitations of a product.

Preferably, the discount amount is calculated in accordance with discount limitations of a store.

Preferably, the computer implemented method further comprises displaying an electronic discount coupon.

Preferably, the electronic discount coupon comprises barcode information

Preferably, the barcode information comprises two-dimensional barcode information

Preferably, the computer implemented method further comprises sending, via the network interface, the electronic discount coupon.

Preferably, the computer implemented method further comprises sending, via a near field communication interface, the electronic discount coupon.

Preferably, the computer implemented method further comprises receiving user selection data representing an instruction to initiate an e-commerce transaction facilitating an e-commerce transaction in accordance with the discount amount.

Preferably, the computer implemented method further comprises sending, via a network interface, the user selection data.

Preferably, the indicia comprises an avatar.

Preferably, the computer implemented method further comprises displaying, using the display device, the indicia over the video scene data in accordance with location data.

Preferably, the computer implemented method further comprises displaying, using the display device, the indicia over the video scene data in accordance with orientation data.

According to another aspect, there is provided a server for promotional offering using augmented reality, the server comprising a processor for processing digital data, a memory device for storing digital data including computer program code and being coupled to the processor, a network interface sending and receiving digital data over a computer network and being coupled to the processor, wherein the processor is controlled by the computer program code to receive, via the network interface, video scene data, identify a promotional offering event, send, via the network interface, an indicia representing the promotional offering event.

Preferably, the processor is controlled by the computer program code to calculate graphical data representing a virtual structure wherein the virtual structure comprises the indicia.

Preferably, the virtual structure comprises a wall.

Preferably, the promotional offering is a discount offering.

Preferably, the processor is further controlled by the computer program code to identify the promotional offering event in accordance with the video scene data.

Preferably, in identifying the promotional offering event, the processor is further controlled by the computer program code to identify a merchant.

Preferably, the processor is further controlled by the computer program code to send, via the network interface, ancillary information data representing ancillary information relating to the merchant.

Preferably, the ancillary information comprises at least one other user who has previously interacted with the merchant.

Preferably, the interaction is an endorsement on a social network.

Preferably, the ancillary information further comprises an image associated with the at least one other user.

Preferably, the processor is further controlled by the computer program code to receive, via the network interface, user selection data representing the user selection of the indicia.

Preferably, the indicia represents an endorsement.

Preferably, the processor is controlled by the computer program code to send, via the network interface, a different indicia after receipt of the user selection data.

Preferably, the processor is further controlled by the computer program code to receive, via the user network interface, social network authentication credentials.

Preferably, the processor is further controlled by the computer program code to send, via the network interface, social graph update data in accordance with the user selection data.

Preferably, the social graph update data relates to a social network.

Preferably, the social graph update data relates to a social network of a merchant.

Preferably, the social graph update data comprises data for publishing notification data on a user's social network account.

Preferably, the social graph update data comprises endorsement data representing an endorsement of a merchant on a user's social network account.

Preferably, the processor, upon receipt of the user selection data, is further controlled by the computer program code to send, via the network interface, promotion data comprising at least one product or service.

Preferably, the processor is further controlled by the computer program code to select the at least one product or service in accordance with profile data of a user.

Preferably, the profile data comprises body proportion data representing at least one body proportion of the user.

Preferably, the at least one product or service relates to two or more products or services of a merchant.

Preferably, the promotion data comprises at least a discount amount associated with the at least one product or service.

Preferably, the processor is further controlled by the computer program code to calculate the discount amount in accordance with a number of users.

Preferably, the processor is further controlled by the computer program code to calculate the discount amount in accordance with a time period.

Preferably, the processor is further controlled by the computer program code to send, via the network interface, the discount amount associated with the at least one product or service as a percentage of a cost price of the at least one product or service.

Preferably, the discount amount is calculated in accordance with social graph data.

Preferably, the discount amount is calculated in accordance with the number of social connections of a social network user.

Preferably, the discount amount is calculated in accordance with influence of a social network user.

Preferably, the discount amount is calculated in accordance with the activity of a social network user.

Preferably, the discount amount is calculated in accordance with a cost price of a product or service.

Preferably, the discount amount is calculated in accordance with a retail price of a product or service.

Preferably, the discount amount is calculated in accordance with a sale price of a product or service.

Preferably, the discount amount is calculated in accordance with discount limitations of a product.

Preferably, the discount amount is calculated in accordance with discount limitations of a store.

Preferably, the processor is further controlled by the computer program code to send, via the network interface an electronic discount coupon.

Preferably, the electronic discount coupon comprises barcode information

Preferably, the barcode information comprises two-dimensional barcode information.

Preferably, the server further comprises a network interface sending and receiving network data and being coupled to the processor, and wherein the processor is further controlled by the computer program code to send, via the network interface, the electronic discount coupon.

Preferably, the processor is further controlled by the computer program code to receive, via the network interface, user selection data representing an instruction to initiate an e-commerce transaction and facilitate an e-commerce transaction in accordance with the discount amount.

Preferably, the indicia comprises an avatar.

Preferably, the processor is further controlled by the computer program code to send, via the network interface, the indicia overlaid the video scene data in accordance with location data.

Preferably, the processor is further controlled by the computer program code to send, via the network interface, the indicia overlaid the video scene data in accordance with orientation data.

Other aspects of the invention are also disclosed.

Although the invention is illustrated and described herein as embodied in a server, a computer readable storage medium, a computer implemented method and a mobile computing device for discounting payment transactions, facilitating discounting using augmented reality and promotional offering using augmented reality, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various exemplary embodiments and to explain various principles and advantages all in accordance with the present invention. Advantages of exemplary embodiments of the present invention will be apparent from the following detailed description of the exemplary embodiments thereof, which description should be considered in conjunction with the accompanying drawings in which:

FIG. 1 is a block circuit diagram of a computing device on which the various exemplary embodiments described herein may be implemented in accordance with an exemplary embodiment of the present invention;

FIG. 2 is a block diagram of a network of computing devices on which the various exemplary embodiments described herein may be implemented in accordance with an exemplary embodiment of the present invention;

FIG. 3 is a block diagram of a network of computing devices on which the various exemplary embodiments described herein may be implemented in accordance with a further exemplary embodiment; and

FIG. 4 is a flow chart illustrating a computer implemented method for discounting payment transactions.

FIG. 5 is a flow chart of an exemplary embodiment of a method for facilitating discounting using augmented reality;

FIG. 6 is a diagrammatic illustration of a mobile computing device implementing an exemplary embodiment of a method for facilitating discounting using augmented reality;

FIG. 7 is a flow chart of an exemplary embodiment of a method for facilitating discounting using augmented reality;

FIG. 8 is a diagrammatic illustration of a mobile computing device implementing an exemplary embodiment of a method for facilitating discounting using augmented reality; and

FIG. 9 is a diagrammatic illustration of an eyewear mobile computing device implementing an exemplary embodiment of a method for facilitating discounting using augmented reality.

### DETAILED DESCRIPTION OF THE INVENTION

As required, detailed exemplary embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate exemplary embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular exemplary embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that exemplary embodiments of the invention described herein may be comprised of one or more conventional processors and unique stored program instructions that control the one or more processors to implement, in conjunction with certain non-processor circuits and other elements, some, most, or all of the functions of the powered injector devices described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various exemplary embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

Computing Device

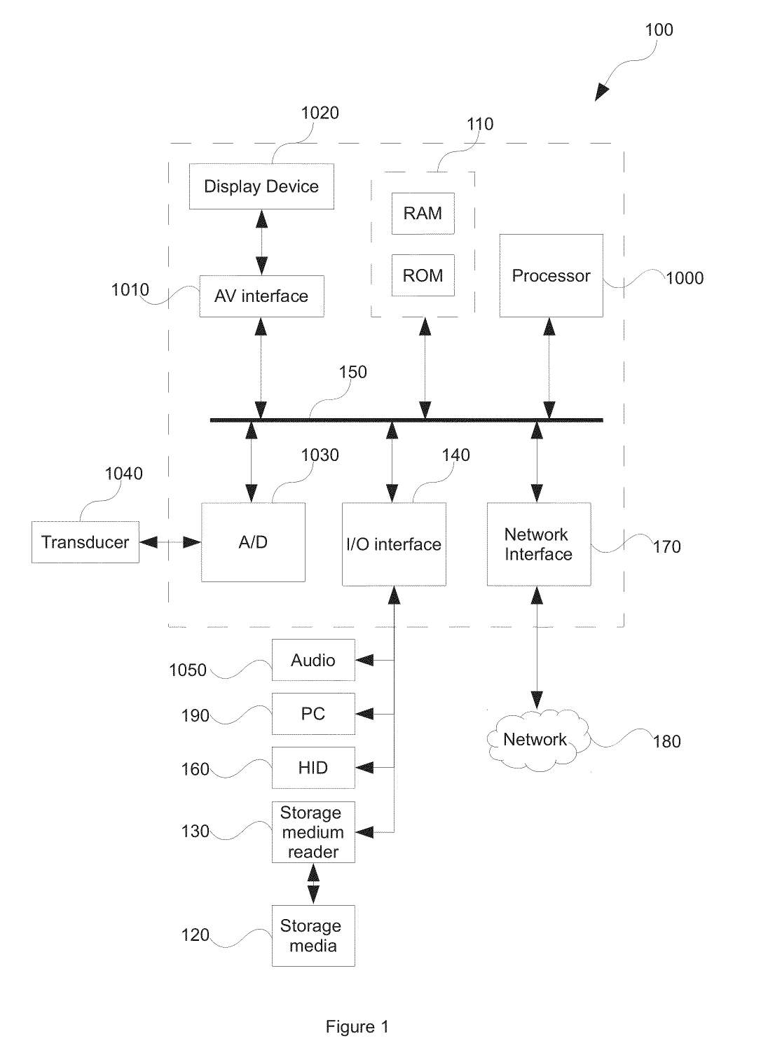

Described now are exemplary embodiments of the present invention. Referring now to the figures of the drawings in detail and first, particularly to FIG. 1, there is shown a first exemplary embodiment of a computing device 100 on which the various embodiments described herein may be implemented. In particular, the steps of a method of discounting payment transactions may be implemented as computer program code instructions executable by the computing device 100. The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The device 100 comprises semiconductor memory 110 comprising volatile memory such as random access memory (RAM) or read only memory (ROM). The memory 100 may comprise either RAM or ROM or a combination of RAM and ROM.

The device 100 comprises a computer program code storage medium reader 130 for reading the computer program code instructions from computer program code storage media 120. The storage media 120 may be optical media such as CD-ROM disks, magnetic media such as floppy disks and tape cassettes or flash media such as USB memory sticks.

The device further comprises I/O interface 140 communicating with one or more peripheral devices. The I/O interface 140 may offer both serial and parallel interface connectivity. For example, the I/O interface 140 may comprise a Small Computer System Interface (SCSI), Universal Serial Bus (USB) or similar I/O interface for interfacing with the storage medium reader 130. The I/O interface 140 may also communicate with one or more human input devices (HID) 160 such as keyboards, pointing devices, joysticks and the like. The I/O interface 140 may also comprise a computer-to-computer interface, such as a Recommended Standard 232 (RS-232) interface, for interfacing the device 100 with one or more personal computer (PC) devices 190. The I/O interface 140 may also comprise an audio interface for communicate audio signals to one or more audio devices 1050, such as a speaker or a buzzer.

The device 100 also comprises a network interface 170 communicating with one or more computer networks 180. The network 180 may be a wired network, such as a wired Ethernet™ network or a wireless network, such as a Bluetooth™ network or IEEE 802.11 network. The network 180 may be a local area network (LAN), such as a home or office computer network, or a wide area network (WAN), such as the Internet or private WAN.

The device 100 comprises an arithmetic logic unit or processor 1000 for performing the computer program code instructions. The processor 1000 may be a reduced instruction set computer (RISC) or complex instruction set computer (CISC) processor or the like. The device 100 further comprises a storage device 1030, such as a magnetic disk hard drive or a solid state disk drive.

Computer program code instructions may be loaded into the storage device 1030 from the storage media 120 using the storage medium reader 130 or from the network 180 using network interface 170. During the bootstrap phase, an operating system and one or more software applications are loaded from the storage device 1030 into the memory 110. During the fetch-decode-execute cycle, the processor 1000 fetches computer program code instructions from memory 110, decodes the instructions into machine code, executes the instructions and stores one or more intermediate results in memory 100.

In this manner, the instructions stored in the memory 110, when retrieved and executed by the processor 1000, may configure the computing device 100 as a special-purpose machine that may perform the functions described herein.

The device 100 also comprises a video interface 1010 for conveying video signals to a display device 1020, such as a liquid crystal display (LCD), cathode-ray tube (CRT) or similar display device.

The device 100 also comprises a communication bus subsystem 150 for interconnecting the various devices described above. The bus subsystem 150 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

Networks of Computing Devices

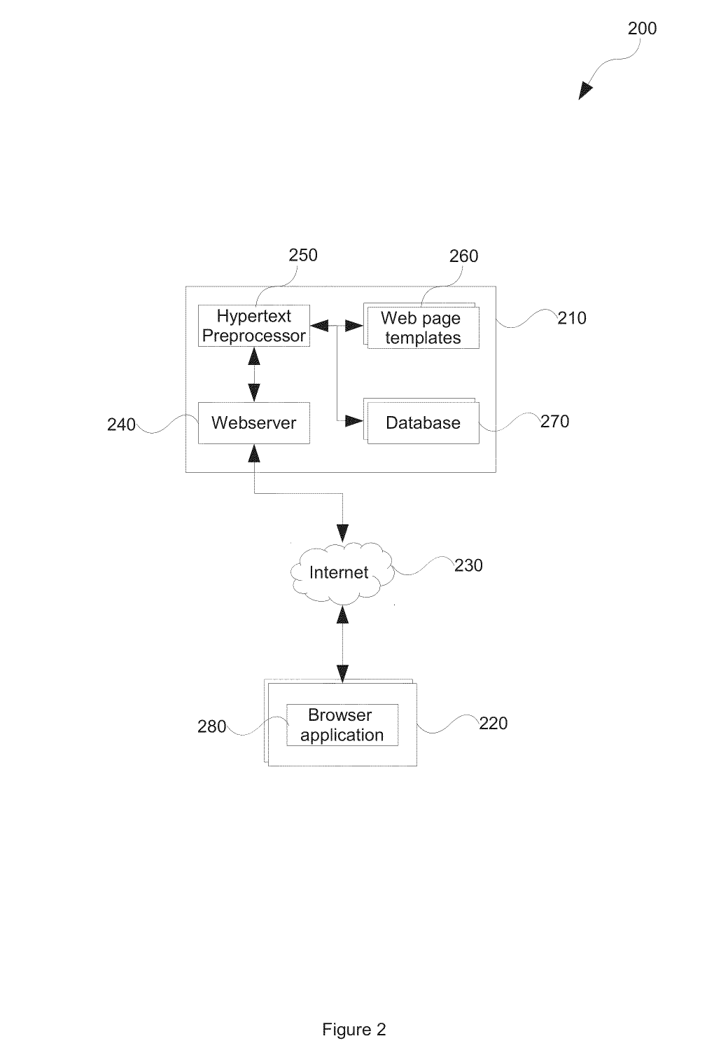

FIG. 2 shows a network 200 of computing devices 100 on which the various exemplary embodiments described herein may be implemented in accordance with one exemplary embodiment. In one embodiment, network 200 is suited for online payment processing, wherein one or more e-commerce platforms, implemented by webservers 210, communicate with one or more customers online in discounting payment transactions.

Note that, in certain exemplary embodiments, the e-commerce platform may be implemented by a first web server 210 wherein a second web server 210, in communication with the first web server 210 implements the discount calculation in accordance with social graph data in the manner described in further detail below.

The network 200 comprises a web server 210 for serving web pages to one or more client computing devices 220 over the Internet 230.

The web server 210 is provided with a web server application 240 for receiving requests, such as Hypertext Transfer Protocol (HTTP) and File Transfer Protocol (FTP) requests, and serving hypertext web pages or files in response. The web server application 240 may be, for example the Apache™ or the Microsoft™ IIS HTTP server.

The web server 210 is also provided with a hypertext preprocessor 250 processing one or more web page templates 260 and data from one or more databases 270 to generate hypertext web pages. The hypertext preprocessor may, for example, be the PHP: Hypertext Preprocessor (PHP) or Microsoft Asp™ hypertext preprocessor. The web server 210 is also provided with web page templates 260, such as one or more PHP or ASP files.

Upon receiving a request from the web server application 240, the hypertext preprocessor 250 retrieves a web page template, from the web page templates 260, executes any dynamic content therein, including updating or loading information from the one or more databases 270, to compose a hypertext web page. The composed hypertext web page may comprise client side code, such as Javascript, for Document Object Model (DOM) manipulating, asynchronous HTTP requests and the like.

Client computing devices 220 are provided with a browser application 280, such as the Mozilla Firefox™ or Microsoft Internet Explorer™ browser applications. The browser application 280 requests hypertext web pages from the web server 210 and renders the hypertext web pages on a display device 1020.

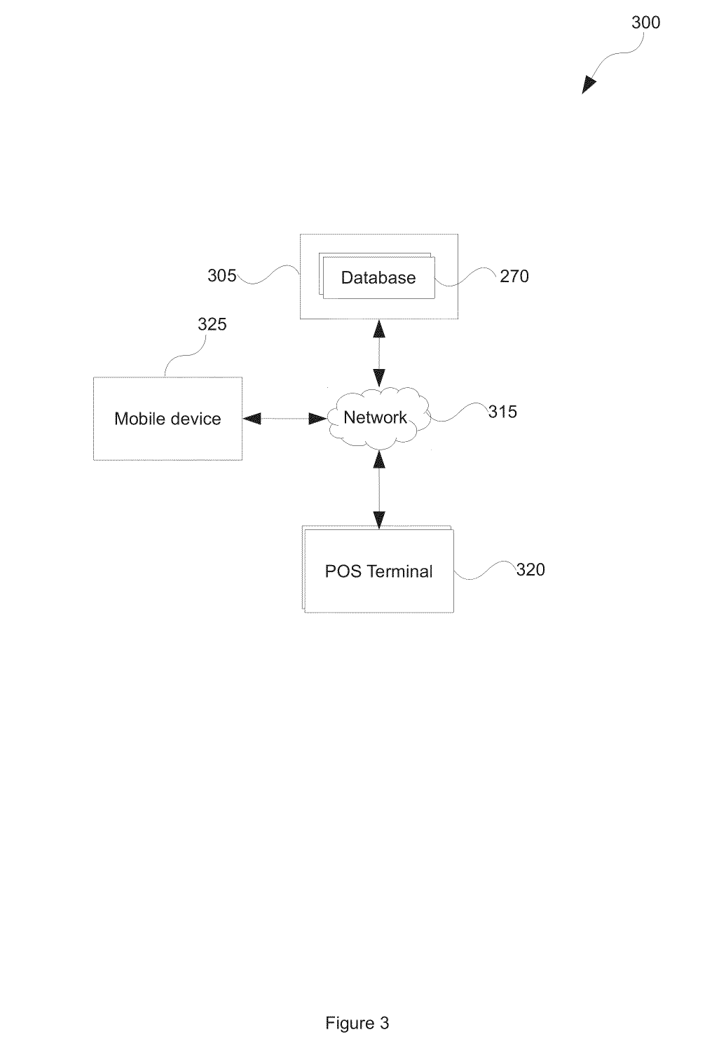

FIG. 3 shows a network 300 of computing devices 100 on which the various exemplary embodiments described herein may be implemented in accordance with a further exemplary embodiment. The network 300 comprises a server 305 coupled to one or more POS Terminals 320 by means of a payment over the Internet 230. The POS Terminals 320 may take the form of standard POS Terminals adapted, by software for example, to communicate with the server 305 for the purposes of calculating a discount for a purchase request in accordance with social graph data, as described in further detail in the manner below. The server 305 comprises a database 270 storing social graph data. In alternative exemplary embodiments, the server 305 may be adapted to communicate with a second server 305, such as a web server 210, across a network such as the Internet network, for the purposes of calculating discount data in accordance with social graph data.

The network 300 comprises a mobile device 325, including smartphones, tablet PCs and the like, such as an Apple™ iPhone™ or the like. It should be noted that, in one specific exemplary embodiment, the mobile device 335 may take the form of an augmented reality device, such as augmented reality glasses adapted to overlay augmented information over a users gaze.

It is noted that, in various exemplary embodiments, the database 270 need not store the social graph data. Rather, the social graph data is fetched and amended using a social graph Application programming interface (API).

It should be noted that, in various exemplary embodiments, other network topologies may be employed in accordance with the actual implementation, suffice to say that one or more computing devices calculate a discount in accordance with a payment transaction request and a social graph.

Discounting Payment Transactions

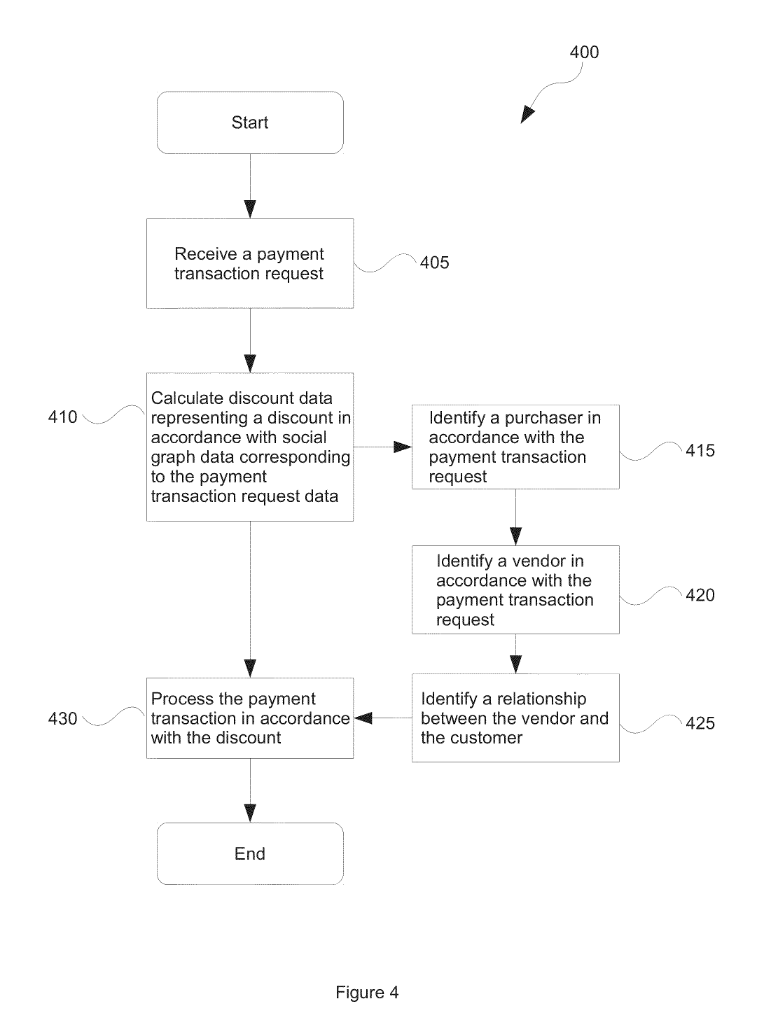

FIG. 4 shows a computer implemented method 400 for discounting payment transactions. The method 400 is executed by one or more computing devices 100 and, in particular, one or more computing devices 100 as substantially shown in FIG. 2 or 3.

The method 400 starts at Step 405 where a payment transaction request is received. The payment transaction request may be received in various manners, such as at a POS terminal 320 in a vendor store or by a web server 210 implementing an e-commerce platform. The payment transaction request represents a request to make payment in respect of a transaction and may therefore comprise data representing the amount of the payment, various details relating to the goods and services in respect of the payment, data identifying the vendor and/or the vendor, a payment instrument and the like. For example, a shopper may have walked into a store, selected an item for purchase and is now presenting payment means at a POS terminal of the store to purchase the item. Alternatively, a shopper may be in the process of using an e-commerce platform and is now conducting the checkout process to pay for one or more items purchased on the e-commerce platform.

At Step 410 of method 400, the computing device 100 calculates discount data representing a discount in accordance with social graph data corresponding to the payment transaction request data for the purposes of discounting the payment transaction by the amount of a discount. For example, the computing device 100 accesses social graph data (such as from database 270 or from a third party server) and computes a discount for the payment transaction request so as to, in one exemplary embodiment, reward certain relationships identified from the social graph data. The discount is calculated in accordance with social graph data. In other words, relationships as represented by the social graph data are used for calculating discount, so as to encourage and reward relations recorded in the social graph data. In such a manner, shoppers are encouraged to amend their social graph data to, for example, endorse a particular vendor, so as to be eligible to receive a discount from the vendor when purchasing an item from the vendor.

In certain exemplary embodiments, the computing device 100 automates the amending of the social graph data of the shopper when facilitating the payment transaction, for example, to update the social graph of the user to become a fan of a merchant, endorse a product, update the social feed of the shopper. For example, if Mary purchases a pair of red shoes from a particular merchant, the computing device 100 may be adapted to send social graph update data to a social platform, such as by using suitable API or the like, to update Mary's social feed to comprise a post that “Mary has just bought a pair of red shoes from ShoesRUs for $29 !”.

Also, in certain exemplary embodiments, the computing device 100 may be adapted to collect social information from a shopper when facilitating a payment transaction, with permission in certain embodiments. For example, when Mary purchases a pair of shoes, the computing device 100 may record that Mary is 16 years of age, has 327 social friends and likes listening to the band Muse.

Once the discount has been calculated, at step 430 of method 400, the computing device 100 is adapted to process the payment transaction in accordance with the discount.

In a preferred embodiment, the computing device 100 calculates the discount in accordance with the relationship between a vendor and a customer. In this manner, a strong relationship as represented by the social graph data may be rewarded by a large discount, thereby encouraging customers to update their social graph data to form relationships with the vendor.

As such, at step 415 of method 400, in this preferred embodiment, the computer 100 identifies a purchaser in accordance with the payment transaction request. Typically, the purchaser is the person submitting the payment request, such as a person standing at a POS terminal 320 in a vendor store or an online shopper using an e-commerce platform. For example, the payment request may comprise data allowing for the identity of the purchaser to be ascertained. For example, the payment request may comprise primary account number (PAN) data such that the computer 100 can look up an identity of the purchaser using the PAN data.

In a similar manner, at step 420, the computer 100 identifies a vendor in accordance with the payment transaction request.

At step 425, the computer 100 identifies a relationship between the purchaser and the vendor in accordance with the social graph data. There are various relationships that may be used as the basis for the relationship. In a first example, the relationship may be a ‘friend’ relationship, wherein the social graph represents that the purchaser is ‘friends with’ or associated with the vendor. In a second example, the relationship may be an ‘endorsement’, where, for example the social graph data represents that the purchaser ‘likes’ the vendor. Other relationships are possible too, such as a post on a news feed of the purchaser about the vendor.

By way of a working example, an implementation of a preferred embodiment will now be described with reference to Jane, an avid shoe shopper. Jane is out shopping one day and notices that Crazy Shoes offers a 5% discount to those purchasers who are recorded as being a ‘friend’ of Crazy Shoes on a particular popular social website. Jane, eager to get her hands on a new pair of red stilettos user her mobile device 325 equipped with an application or Internet browsing device to update her social graph data to add Crazy Shoes as a friend.

Specifically, a software application on Jane's mobile device 325 ascertains the location of Jane using an in-built or on-board GPS device of the mobile device 325. Location coordinates are sent from Jane's phone to the web server 210. The web server 210 retrieves from the database 270 a list of vendors proximate to Jane's location. The list of vendors is sent back to Jane's mobile device 325, the list including Crazy Shoes. Jane selects Crazy Shoes and the selection is sent back to the web server 210. The web server 210 then, using a social platform API, sends an update request to a social platform to add Crazy Shoes as a friend of Jane's. In this manner, the social platform may publish a notification on Jane's social news feed that Jane is now friends with Crazy Shoes. Once the social graph data has been updated in this manner, a verification code is sent back to Jane's mobile device 325 as confirmation. Jane then shows the verification code to Crazy Shoes in order to receive the discount.

There are a number of manners by which the verification code may be provided. In one example, the verification code may be an alphanumeric code that is provided to Crazy Shoes. A Crazy Shoes employee may enter the verification code into the POS terminal 320 for verification. Alternatively, Jane's mobile device 325 may display a barcode for scanning by a barcode reader of the POS terminal 320. Preferably, the barcode used is a 2D barcode such that information, such as the verification number, can be encoded in the barcode. In alternative embodiments the POS terminal 320 may be adapted to communicate directly with the web server 210 for verification purposes such that Jane need not provide the verification code.

In one exemplary embodiment, the computing device 100 may provide a discount according to n, where n is the n^{th} degree of separation between the purchaser and the vendor. For example, if the purchaser is a direct friend with the vendor, that is a friend of the 1^{st} degree, the computer 100 may be adapted to calculate a discount of 5%. However, if the purchaser is an indirect friend with the vendor, that is a friend of the 2^{nd} 3^{rd} and so on degree, the computer 100 may be adapted to calculate a discount of less than 5%, such as 2.5%, for example.

In calculating the degrees of separation between the customer and the vendor in accordance with the social graph, the computer 100 is adapted to calculate the shortest relationship path between the vendor and the customer. As such, calculating the discount further comprises calculating a shortest relationship path between the purchaser and the vendor in accordance with the social graph and calculating the discount further in accordance with the shortest relationship path. In this manner, the computer 100 is adapted to calculate the discount further in accordance with the length of the shortest relationship path.

As alluded to above, one of the relationships that may be relied upon by the computer 100 in calculating the discount is the ‘friend’ relationship. Where the purchaser and the vendor are not friends, the computer 100 may be allowed to amend the social graph data to establish such a relationship. As such, the computer 100 identifies the purchaser in accordance with the payment transaction request, identifies the vendor in accordance with the payment transaction request, and amends the social graph to establish a relationship between the purchaser and the vendor. As alluded to above, the social graph data may reside within database 270 or may be located remotely on a 3^{rd} party content server, updatable and accessible by way of an API.

In one exemplary embodiment, the computer 100 may amend the social graph data to publish to a news feed of the purchaser a notification in relation to the purchase. For example, using the example above, the notification may comprise the message ‘Jane just received a 5% on a $200 pair of red stilettos from Crazy Shoes’. In this manner, the computer 100 identifies the purchaser in accordance with the payment transaction request, identifies the vendor in accordance with the payment transaction request, and publishes a notification using a feed associated with the purchaser or purchase.

In various exemplary embodiments the notification may comprise an identity of the vendor, the calculated discount (represented as a monetary amount of a percentage off the sales price) and the sales price.

In one exemplary embodiment, in calculating the discount, the computer 100 offers a greater or lesser discount for expensive items. In this manner, the computer 100 calculates a price in accordance with the payment transaction request and calculates the discount further in accordance with the price. For example, an item sold for $1,000 may attract a discount of 5% while an item sold for $100 may attract a discount of 3%.

In a yet further exemplary embodiment, the computer 100 is adapted for offering a variable discount based on purchaser's level of ‘social influence’. Social influence can be calculated from various metrics using the social graph data. Once such metric is the number of social connections a person has. In this manner, the computer identifies the purchaser in accordance with the payment transaction request, counts a number of social connections of the purchaser in accordance with the social graph data, and calculates the discount further in accordance with the number of social connections.

In another exemplary embodiment, the computer 100 offers a variable discount based on the purchaser's feedback in respect of the vendor. For example, the computer 100 may calculate a larger discount for a purchaser who has posted numerous posts on their social feed about the vendor as opposed to a purchaser who has posted none or very little. In this manner, the computer 100 identifies a purchaser in accordance with the payment transaction request, counts a number of posts associated with the purchaser in accordance with the social graph data, and calculates the discount further in accordance with the number of posts.

The computer 100 may employ keyword marching techniques to identify those posts relating to the vendor and comprising positive sentiment (e.g. comprising words such as ‘great’ and ‘happy’). In this manner, the computer 100 identifies a vendor in accordance with the payment transaction request, counts a number of posts associated with the vendor in accordance with the social graph data, and calculates the discount further in accordance with the number of posts.

In a certain exemplary embodiment, the vendors may be able to configure the discount offered. For example, vendor A may only wish to offer a discount of 5% across all items, whereas vendor B may wish to offer a discount from 5% to 10% depending on the sales price. In this manner, the computer identifies a vendor in accordance with the payment transaction request and calculates the discount further in accordance with the vendor. Similarly, where the discount is based on the type of product, the computer 100 identifies a product in accordance with the payment transaction request and calculates the discount further in accordance with the product.

Furthermore, the computer 100 may be adapted for calculating variable discounts based on other parameters, such as in accordance with a time of day, payment instrument and the like.

In a further embodiment, the computer 100 may be adapted for calculating whether the target market demographic of a product coincides with the demographic of the purchaser, such that should, for example, the target market demographic fall outside the demographic of the purchaser, the computer 100 is adapted to increment the discount so as to induce the purchase. For example, should the computer 100 determine from the social graph data that a female purchaser is in her 30s and that the purchaser is seeking to purchase a pair of skinny jeans, which, according to historical sales records indicates are usually sold to 16-year-olds, the computer 100 may be adapted to apply a higher discount as compared to where the purchaser in her teens.

In alternative embodiments, the computer 100 may be adapted to apply to apply a discount based on the purchases level of influence including within a specific demographic. Specifically, if the product being purchased has a target market in demographic A, and the purchaser is from demographic B according to the purchaser's social graph data, then the computer 100 is adapted to calculate the discount depending on the extent of correlation between demographic A and demographic B.

In a yet further embodiment, the system 200, 300 is adapted for sending a notification to the mobile device 325 of the purchaser to complete the discounting process. The notification may take on various forms depending on the application such as short message service (SMS), push notification and the like. The notification may be for the purposes of confirming the discount with the purchaser. For example, the computer 100 may receive a response to the notification and process a payment transaction in accordance with the discount upon receipt of the response. The notification may also be for the purposes of confirming a posting of a notification to the social feed of the purchaser. For example, the computer 100 is adapted for receiving a response to the notification and publishing a notification using a feed associated with the purchaser. The notification may comprise the name of a vendor, the name of a product, the discount and the like. The notification may also be for the purposes of confirming the amendment of the social graph data to connect the purchaser and the vendor. For example, the notification might say ‘Click to add Crazy Shoes as a friend to receive a discount of 5%’.

Facilitating Discounting Using Augmented Reality

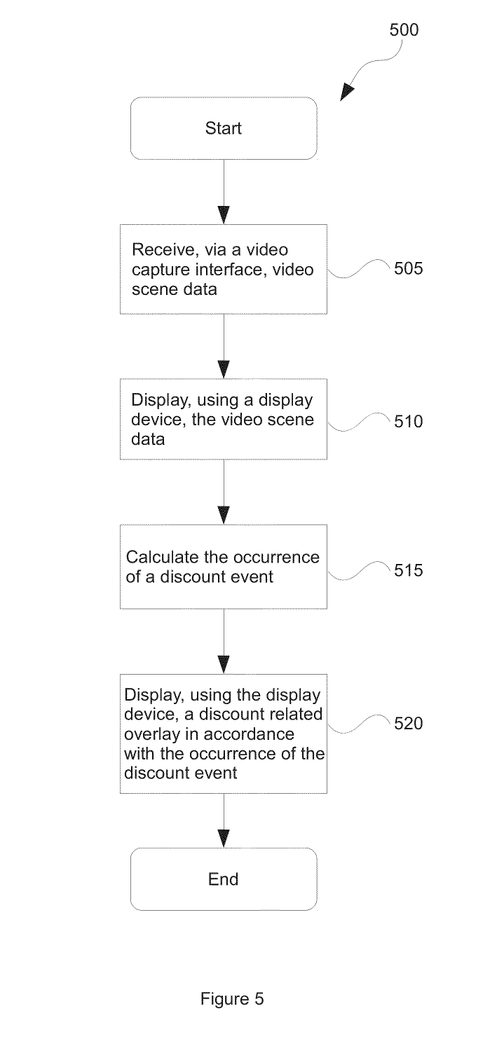

FIG. 5 shows a computer implemented method 500 for facilitating discounting using augmented reality. The method 500 is executed by the mobile computing device 100, such as wherein the mobile computing devices 100 is a smartphone or the like. Specifically, the mobile computing device 100 according to a preferred embodiment comprises a processor 100 for processing digital data, a memory device 110 for storing digital data including computer program code and being coupled to the processor 1000, a video capture interface 1025 (such as a forward or rearward facing camera) for capturing video scene data and being coupled to the processor 1000, and a display device 1020 (such as an LED touch sensitive screen) for displaying the video scene data and being coupled to the processor 1000.

As will be apparent from the disclosure herein, the mobile computing device 100 is adapted to facilitate the provision of augmented reality discounting. In a preferred embodiment, the mobile computing device 100 is adapted for capturing and displaying video data, wherein the mobile computing device 100 overlays a discount over the video data. In this manner, a shopper can walk through a shopping district, holding the mobile computing device 100 at eye level to view the captured video data. Where the mobile computing device 100 detects the occurrence of a discount event, the mobile computing device 100 may display a discount over the video data. For example, if the mobile computing device 100 is displaying video data of a dress, the mobile computing device 100 may calculate that the dress is available at a discount, and display the discounted price over the dress. Such an implementation advantageously allows vendors to attract customers.

As such, at step 505 of method 500, the mobile computing device 100 is adapted to receive, via the video capture interface 1025 the video scene data.

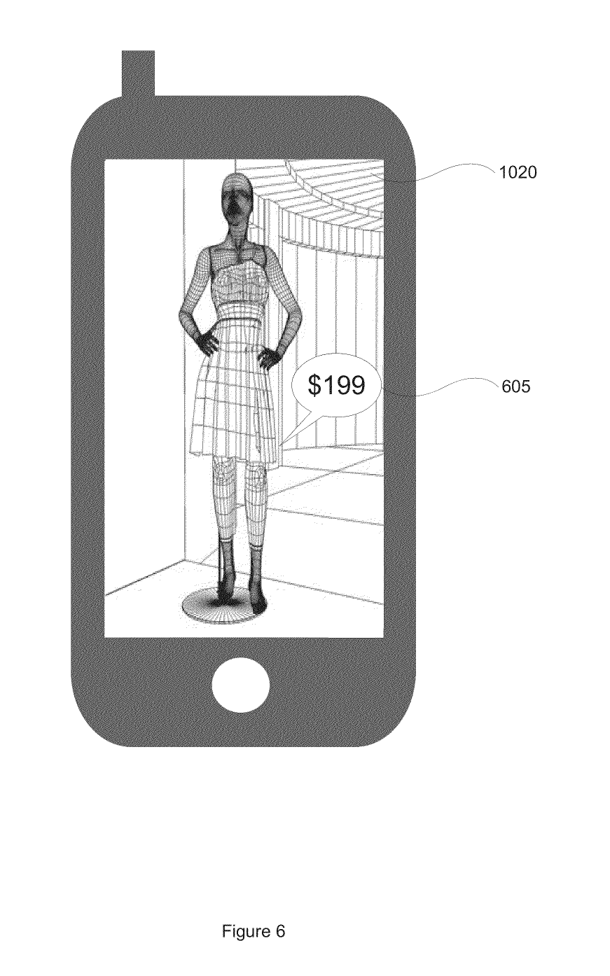

Turning now to FIG. 6, there is shown an exemplary mobile computing device 100 having a display device 1020. In this embodiment, the mobile computing device 100 has the video capture interface 1025 at the rear of the mobile computing device 100.

At step 510 of method 500, the mobile computing device 100 is adapted to display, using the display device 1020, the video scene data.

In this embodiment, the mobile computing device 100 is shown displaying video data depicting a shop window comprising a red dress for sale.

At step 515 the mobile computing device 100 is adapted to calculate the occurrence of a discount event. There are various manners by which the mobile computing device 100 is adapted to calculate the occurrence of the discount event, some of which are described in further detail below. Herein, for example, the mobile computing device 100 may be adapted to determine that the dress shown in the video data is available on discount.

As such, at step 520, the mobile computing device 100 is adapted to display, using the display device 1020, a discount related overlay in accordance with the occurrence of the discount event. In the embodiment shown in FIG. 6, the discount related overlay is shown as speech bubble 605 depicting the discount price. The discount-related overlay may comprise further information too, such as the original price, the percentage discount, the time remaining for the discount and the like.

Various manners by which the mobile computing device 100 is adapted to calculate the occurrence of a discount event are now discussed below.

In a first exemplary embodiment, the mobile computing device 100 is adapted to calculate the occurrence of the discount event using an image recognition algorithm having as input the video scene data. For example, the image recognition algorithm may use a color recognition technique, wherein, for example, the red dress is recognized. However, the image recognition algorithm preferably uses a shape recognition technique, wherein, for example, the mobile computing device 100 used edge discriminator techniques to identify an outer shape of an item or product, and compares the outer shape to a database of known items or products to identify the item or product.

In one exemplary embodiment, the image recognition algorithm comprises a barcode recognition technique. In this manner, the mobile computing device 100 may read the barcode, and use the barcode data to look up product data, such as from a product data database, to identify the price and/or discount applicable to the product. Note that in one exemplary embodiment, the mobile computing device 100 may be adapted for use with price tags, wherein the mobile computing device 100 is able to recognize and determine the location of a price, so as to be able to overlay a discounted price over the price in the video scene data.

In one exemplary embodiment, the image recognition algorithm is adapted to identify items other than products. For example, image recognition algorithm may be used to recognize a store, such as by recognizing the Golden Arches™ of a MacDonalds™ franchise, so as to be able to display a discount overlay (such as a wrapped present icon or an avatar of a clown) in front of the store in the video scene data.

In one exemplary embodiment, the mobile computing device 100 further comprises location sensor for sensing location data and being coupled to the processor 1000. In this manner, in calculating the occurrence of the discount event, the mobile computing device 100 is able to calculate the occurrence of the discount event in accordance with the location data. The location data may be used to supplement the image data in determining the discount event. For example, where the mobile computing device 100 recognizes a red dress, the mobile computing device 100 may then use the location data to narrow down the number of matching red dress products.

In a further exemplary embodiment, the mobile computing device 100 further comprises an orientation sensor (such as a tri-axial gyroscope) for sensing orientation data and being coupled to the processor 100. In this manner, the mobile computing device 100 is able to calculate the occurrence of the discount event in accordance with the orientation data.

For example, referring to FIG. 6, the mobile computing device 100 is able calculate a display location of the dress in accordance with the orientation data so as to be able to display the callout overlay 605 in the correct position. In this manner, as the mobile computing device 100 is tilted, the location of the callout overlay 605 moves accordingly. Such a technique is advantageous in applications where image recognition is not possible, such as where the mobile computing device 100 is displaying callout overlays 605 for products out of view inside a store where the mobile computing device 100 is located outside the store.

The discount related overlay 205 may comprises an avatar in one embodiment, such as an animated clown, for example. The mobile computing device 100 discount related overlay may also comprise a redeemable token that, for example, is redeemed when the user ‘walks through’ the token. In this manner, a user, visiting a set of stores in a franchise, may collect points to use in one of the stores of the franchise.

In one exemplary embodiment, the mobile computing device 100 is adapted to calculate discount data in accordance with the discount event. Typically, the mobile computing device 100 will recognize a price, or obtain a price from a data server, and then calculate a discount for the price. In a preferred embodiment, the mobile computing device 100 is able to calculate the discount data in accordance with a social graph, such as where the user of the mobile computing device 100 has indicated on their social platform that they are ‘friends’ with the store in question.

Promotional Offering Using Augmented Reality

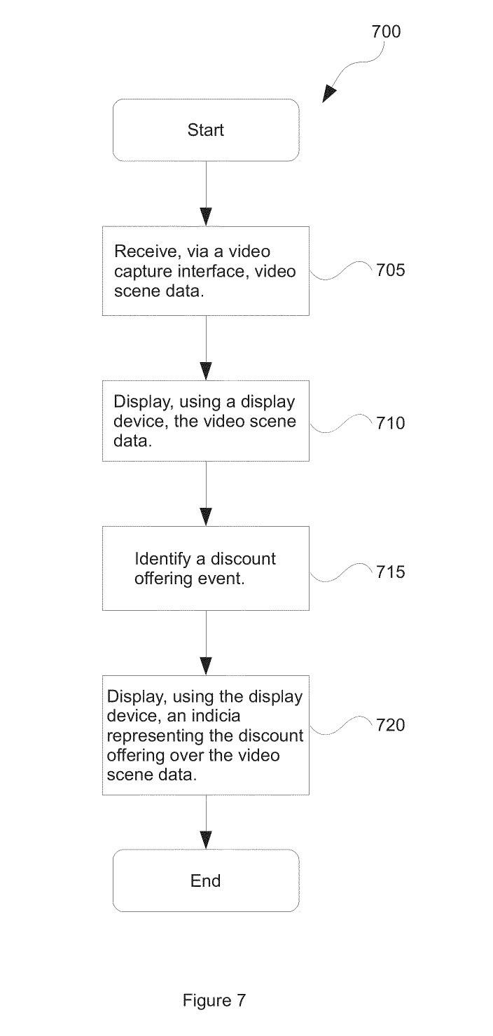

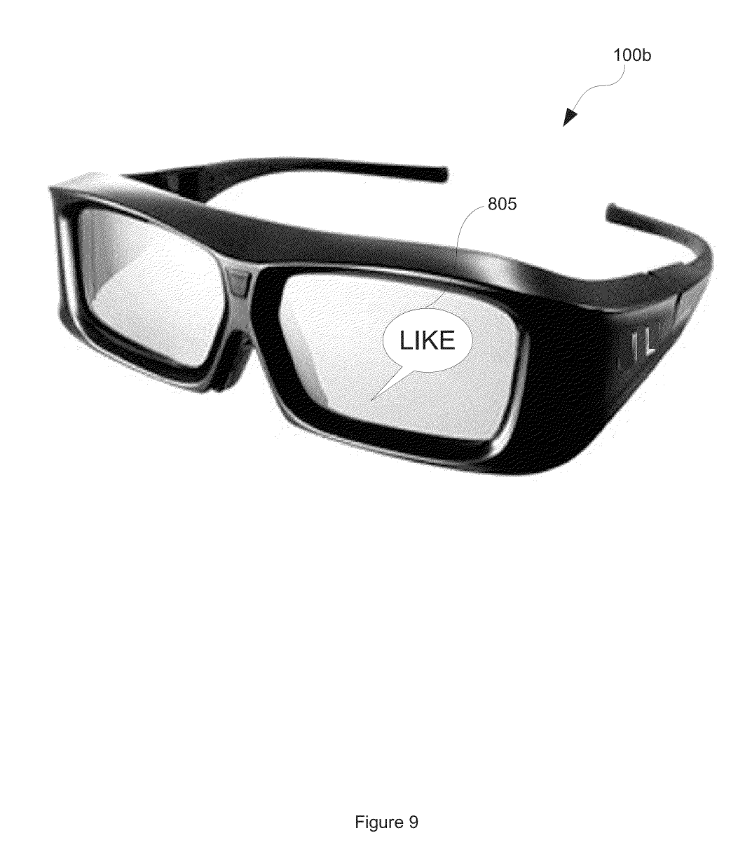

FIG. 7 shows an exemplary computer implemented method 700 for facilitating discounting using augmented reality. In one exemplary embodiment, the method 700 may be implemented by the mobile computing device 100, a tablet computing device and the like. In another exemplary embodiment, the mobile computing device 100 may take the form of a wearable device such as a headset, such as eyeware having an active display overlay as substantially shown in FIG. 9, superimposing the information described herein over the user's vision as described in further detail below.

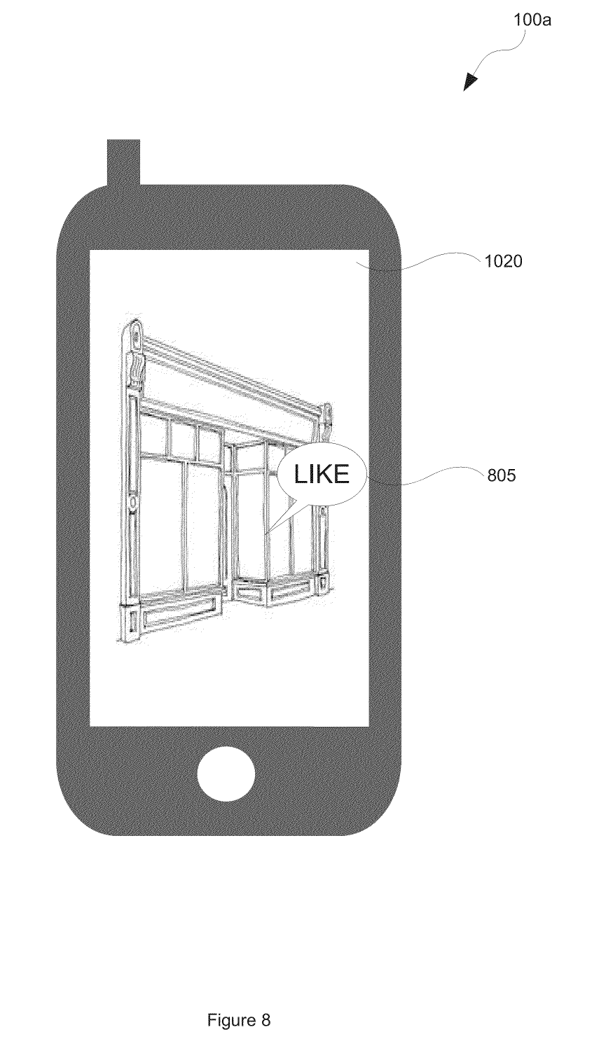

As will be apparent from the disclosure herein, the mobile computing device 100 is adapted to facilitate the provision of augmented reality promotional offering in the social network context. In a preferred embodiment, the mobile computing device 100 is adapted for capturing and displaying video data, wherein the mobile computing device 100 overlays a promotional offering over the video data. The promotional offering may take on various forms depending on the application, such as a ‘2 for 1’ promotional offering, or a discount promotional offering, such as 5% off sales price. Generally, the promotional offering is an invitation to the user to engage with the merchant and receive the promotional offering (such as a discount) as a reward. As will be described further below, in this embodiment, the offering of the discount is in accordance with social network data. The promotional offering could be a promotional offering, or an offering allowing a user to endorse a merchant in order to receive a discount. For example, a shopper can walk through a shopping district, holding the mobile computing device 100a (see FIG. 8) at eye level to view the captured video data or wearing the mobile computing device 100b (see FIG. 9). Where the mobile computing device 100 detects the occurrence of a discount event, the mobile computing device 100 may display an indicia 805 representing the discount over the video data. For example, if the mobile computing device 100 is displaying video data of a merchant store front, the mobile computing device 100 may calculate that the merchant offers discounts, and display the indicia over the video of the merchant storefront. Such an implementation advantageously allows merchants to attract customers.

At step 705 of method 700, the mobile computing device 100 is adapted to receive, via the video capture interface the video scene data.

Turning now to FIG. 8, there is shown an exemplary mobile computing device 100 having a display device 1020. In this embodiment, the mobile computing device 100 has the video capture interface at the rear of the mobile computing device 100.

At step 710 of method 700, the mobile computing device 100 is adapted to display, using the display device 1020, the video scene data.

In the embodiment given in FIG. 8, the mobile computing device 100 is displaying video scene data representing a storefront. Note that in certain embodiments the mobile computing device 100 need not display the video scene data, but merely needs to overlay information over a translucent screen. For example, considering FIG. 9, the mobile computing device 100 is able to display information overlaid the lenses of the headset.

At step 715 the mobile computing device 100 is adapted to calculate the occurrence of a discount event. There are various manners by which the mobile computing device 100 is adapted to calculate the occurrence of the discount event, some of which are described in further detail below. Herein, for example, the mobile computing device 100 may be adapted to determine that the storefront shown in the video scene data is associated with a promotional offering.

There are various manners by which the mobile computing device 100 is adapted to calculate the occurrence of a discount event are now discussed below.

In a first exemplary embodiment, the mobile computing device 100 is adapted to calculate the occurrence of the discount event using an image recognition algorithm having as input the video scene data. For example, the mobile computing device 100 may be adapted to recognize the visual features of the storefront. The visual features may comprise textual hints, wherein, for example, the mobile computing device 100 uses optical character recognition to read the name of the store. In another embodiment, the image recognition algorithm is adapted to identify the occurrence of a discount event by other means, such as by recognizing a logo such as the Golden Arches™ of a MacDonalds™ franchise.

In another example, the mobile computing device 100 may compare the scene data to a database of known scene data, such as by comparison with the Google™ Streetview™ database. Note that, given the large dataset, the video scene data or parts thereof may be communicated to a central image-processing server for comparison.

In one exemplary embodiment, the mobile computing device 100 further comprises location sensor 185 for sensing location data and being coupled to the processor 1000. In this manner, in calculating the occurrence of the discount event, the mobile computing device 100 is able to calculate the occurrence of the discount event in accordance with the location data. The location data may be used to supplement the image data in determining the discount event. For example, the mobile computing device 100 may then use the location data to narrow down the number of matching red dress products.

In a further exemplary embodiment, the mobile computing device 100 further comprises orientation sensor (such as a tri-axial gyroscope) for sensing orientation data and being coupled to the processor 100. In this manner, the mobile computing device 100 is able to calculate the occurrence of the discount event in accordance with the orientation data. For example, were the mobile computing device 100 in the middle of a street, the mobile computing device 100 would be able to ascertain the orientation direction so as to be able to discriminate between a store on the left or right hand side of the road.

The orientation data may also be used by the mobile computing device 100 to display the indicia (discussed below) on the correct position of the screen.

For example, referring to FIG. 8, the mobile computing device 100 is able calculate a display location of the store in accordance with the orientation data so as to be able to display the indicia 805 in the correct position. In this manner, as the mobile computing device 100 is tilted, the location of the callout indicia 805 moves accordingly.

At step 300, the mobile computing device 100 is adapted to display, using the display device 1020, an indicia 805 representing the promotional offering over the video scene data. In the embodiment shown in FIG. 8, the indicia 805 is shown as speech bubble 805, but may take the form of alternative representations.

In one exemplary embodiment, in addition to the mobile computing device 100 identifying the promotional offering event in accordance with the video scene data, the mobile computing device 100 may be adapted to identify a merchant in accordance with the video scene data. The mobile computing device 100 may also display, ancillary information data representing ancillary information relating to the merchant such as the store opening hours or social media profile information of other friends who have liked the store or made prior purchases at the store such as the other friends' names, social media profile photo and the like. The ancillary information may be displayed in virtual reality by the device 100, or my other measures, such as on a social media web page and the like.

Now, the user, viewing the indicia 805, is able to activate the indicia 805 in various manners to receive a reward, discount and the like. As such, the indicia 805 is preferably user selectable. The indicia 805 may be user selectable in various manners, such as by way of a touch sensitive display device 1020 or by gesture recognition using the video capture device, such that, for example, where the user is using the glasses as substantially shown in FIG. 9, the user is able to gesture with arm motions corresponding to the user's view of the indicia.

In another example, the user would be able to use voice commands, such as ‘like this store’ to activate the indicia. The mobile computing device 100 may be adapted to use the audio device 1050 to capture these voice signals from the user.

In an exemplary embodiment, the indicia 805 represents an endorsement. In FIGS. 6 and 8, the indicia 805 is shown as a ‘like’ button. As such, activating the indicia 805 is permission from the user for their social profile to be updated to reflect their ‘like’ of the store or merchant. In this manner, the store or merchant gains a social following in exchange for discounts and the like. The mobile computing device 100 may be adapted to send, via the network interface 170, social graph update data in accordance with the user selection data so as to update the user's profile on a third party social platform, such as by way of an API call.

The user's social data may be updated in various manners, such as by having a notification published to their social news feed (which notification may comprise various information, such as the name of the store or merchant, the time of day and the like). Alternatively, the users social graph may be updated to reflect the ‘like’ or endorsement of the store or merchant, or the establishment of a connection between the user's social profile and that of the merchant or store (i.e., a friend connection).

Now, having received permission from the user to amend their social graph by way of activation of the indicia 805, the mobile computing device 100 may be adapted to display, using the display device 1020, promotion data representing at least one product and at least a discount amount associated with the at least one product. For example, should the particular merchant or store stock handbags, at least one handbag may be displayed on offer at a discounted cost. The discount amount may be displayed as percentage of a cost price of the at least one product or service.

The discount amount may be calculated in various manners, such as in accordance with social graph data. For example, the discount amount may be calculated in accordance with the number of social connections of a social network use, the ‘influence’ (e.g., number of friends or followers) of a social network user, with the activity of a social network user and the like. Other factors such as a cost price of a product, a retail price of a product, and a sale price of a product may also be used. Various limitations on the discount offered may be put in place, such as in accordance with discount limitations of a product, the store and the like. The mobile computing device 100 may be adapted to display to the user a coupon code so that the user can present the coupon code in store to receive a discount.

In an exemplary embodiment, the mobile computing device 100 may be adapted to allow the user to purchase the product. For example, the mobile computing device 100 could allow the user to instruct the purchase of a product or service (such as by using a credit card) such that the mobile computing device 100 may be adapted to facilitate an e-commerce transaction in accordance with the discount amount.

For example, the mobile computing device 100 may be able to display a range of products available at a discount to the user. The mobile computing device 100 may be adapted to display the discounted price associated with each of the products, and the original price if necessary. As alluded to above, the mobile computing device 100 may be able to utilize gesture recognition to allow the user to interact with the range of products to select at least one of the range of products that the user would like to purchase. For example, the mobile computing device 100 may be adapted to allow the user to drag the at least one of the range of products into a virtual ‘shopping basket’. The mobile computing device 100 or the server 210 may have access to the users payment credentials such that the user can ‘checkout’ in a fast manner, without having to enter in their credentials. However, in one exemplary embodiment, the user may enter their credentials for payment by ‘looking’ at their credit card. That is, the user may direct the video capture device of the mobile computing device 100 towards their credit card, such as by the user holding the credit card in the user's gaze where the user is wearing the glasses as shown in FIG. 9. The user may be required to ‘show’ the front and the back of the credit card to the mobile computing device 100 for sufficient data capture. The mobile computing device 100 may be adapted to employ image recognition techniques to ascertain the credit card information. Alternatively, the mobile computing device 100 may send the captured images to the server 210 for processing in a similar manner.

Also as alluded to above, the user would be able to use voice commands, such as ‘buy the red handbag’ to purchase a product. The mobile computing device 100 may be adapted to use the audio device 1050 to capture these voice signals from the user.

In one exemplary embodiment, the indicia comprises an animated avatar for better user engagement.

Context

An exemplary embodiment will now be described in context wherein a user is standing on the street or in a shopping mall and observes a storefront in augmented reality on his tablet, glasses or other heads-up style display mobile device 100. An image appears overlaying the shopfront or next to it. The image includes images of product or service offers available to consumers who have connected with the store. These images may be greyed out or altered in another way prior to the user connecting with the store, an indicia in the form of an icon with the word “like” which, when selected, creates a connection between the user and the store. Any indicia can be used, it merely needs to be indicative that selecting it will cause a connection between the user and the store, images of friends of the user who have previously connected with the store, and/or a newsfeed from the store and/or a virtual assistant or avatar who the user can talk with or message.

The images are received by the mobile device 100 from a server via a wireless connection with the server 210. The word “image” is used above to refer to a static or dynamic (e.g., video) image.

In connecting with the store the user then says “like” or points at the “like” icon. The microphone 1050 or forward facing camera of the user's mobile device 100, respectively, detects the user's selection. This selection is sent to the server by the mobile device 100. The server 210 then causes a connection between the consumer and the store to be created.

This connection may take place on a social media network such as Facebook™ by the “like” functionality, Twitter™ by the “follow” functionality or on any other social network. Different stores may have a profile or presence on different social networks or offer the user the ability to choose one or more of a group of social networks. It is noted that the user may be prompted by software on their mobile device 100 to enter a username and password associated with the relevant or chosen social network if the mobile device is not already signed-in.

Alternatively, the connection may take place directly with the store to a backend of its own loyalty software.

In selecting an offer, the images of product or service offers then change to become selectable by the user by the same type of voice or pointing selection as described above. It is noted that any selection method may be used according to available selection technology.

If the images originally showed a price, the changed images may show a discounted price being offered by the store because the user has connected to it. The changed images may also display another type of offer in the product or service images.

The user then selects one or more of the images of product or service offers. The images of the selected product or service offers then change to show that they have been selected. The social network is prompted by the server to display a notification in the user's feed or profile to advertise to friends of the person (according the user's social media privacy settings) that the user has obtained an offer from the store. A range of information relating the product, purchase, discount or other offer or store can be displayed.

In obtaining the offer, the server 210 then generates a coupon that the user can show the store sales person. The coupon may include a bar code or QR code. The coupon may be delivered electronically to the user's screen, delivered to the user's email address or not displayed but obtainable by the user by passing their phone in the proximity of a near field communications device in the store. Alternatively or additionally the server may cause the selected products or services to be purchasable by an electronic payment on the user's mobile phone using a technology such as Google™ Wallet.

In an alternative exemplary embodiment, images of products or services are not shown but a store image or just the connection indicia is shown. When the user has connected with the store, the store image or connection indicia changes to display a store-wide offer.

In an alternative exemplary embodiment, a text description or message takes the place of some or all images.

Augmented Reality ‘Wall’

According to one exemplary aspect, the system 200 may be adapted to implement augmented reality objects, structures and the like, such as an augmented reality ‘wall’ wherein the indicia is displayed on the wall. In this manner, no physical storefront is necessary in promotional offering. The system 200 may further be adapted to allow multiple friends to connect to with a store or merchant at the wall so as to obtain a obtain a group discount. For example, the system 200 could be adapted such that should in excess of 50 people ‘flash mob’, congregate or connect with the store or merchant at a wall, the system 200 is adapted to award those present with a promotional offering. The system 200 may be adapted to offer the promotion only if the users connect at the same time, or during a time period.

Where the promotional offering related to apparel such as clothing and the like, the system may be adapted to store profile data about the user. The profile data may comprise clothing preferences of the user or body measurements of the user, such as height, arm length and the like. In this manner, the apparel promoted by the system 200 may be selected by the system 200 in accordance with the profile data of the user.

Interpretation

Social Graph The term social graph as used herein is a data structure comprising one or more connections describing the relationships between individuals and the relationships between individuals online in one embodiment.

Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

In accordance with

As described herein, ‘in accordance with’ may also mean ‘as a function of’ and is not necessarily limited to the integers specified in relation thereto.

Composite Items

As described herein, ‘a computer implemented method’ should not necessarily be inferred as being performed by a single computing device such that the steps of the method may be performed by more than one cooperating computing devices. Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

Wireless

The invention may be embodied using devices conforming to other network standards and for other applications, including, for example other WLAN standards and other wireless standards. Applications that can be accommodated include IEEE 802.11 wireless LANs and links, and wireless Ethernet. In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

Processes

Unless specifically stated otherwise, as apparent from the following discussions, it is appreciated that throughout the specification discussions utilizing terms such as “processing”, “computing”, “calculating”, “determining”, “analyzing” or the like, refer to the action and/or processes of a computer or computing system, or similar electronic computing device, that manipulate and/or transform data represented as physical, such as electronic, quantities into other data similarly represented as physical quantities.

Processor

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors. The methodologies described herein are, in one exemplary embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

Computer-Readable Medium

Furthermore, a computer-readable carrier medium may form, or be included in a computer program product. A computer program product can be stored on a computer usable carrier medium, the computer program product comprising a computer readable program means for causing a processor to perform a method as described herein.

Networked or Multiple Processors:

In alternative exemplary embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine. Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### ADDITIONAL EMBODIMENTS

Thus, one exemplary embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

Carrier Medium

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

Implementation

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Means for Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment,” “exemplary embodiment,” or “an embodiment” means that a particular feature, structure or characteristic described in connection with the embodiment is included in at least one embodiment of the present invention. Thus, appearances of the phrases “in one embodiment,” “in an exemplary embodiment,” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments. Similarly it should be appreciated that, in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention. Any one of the terms including or which includes or that includes as used herein is also an open term that also means including at least the elements/features that follow the term, but not excluding others. Thus, including is synonymous with and means comprising.

Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention. Although the invention has been described with reference to specific examples, it will be appreciated by those skilled in the art that the invention may be embodied in many other forms.

### INDUSTRIAL APPLICABILITY

It is apparent from the above, that the arrangements described are applicable to the payment processing industries.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A mobile computing device for facilitating discounting using augmented reality, the mobile computing device comprising:
a processor structured to process digital data and to execute computer program code;
a memory device coupled to the processor and storing the digital data including the computer program code;
a video capture interface coupled to the processor and capturing video scene data;
a display device coupled to the processor and displaying the video scene data;
wherein the processor is controlled by the computer program code to:
receive, via the video capture interface, the video scene data;
display, using the display device, the video scene data;
determine an occurrence of a discount event; and
display, using the display device, a discount related overlay in accordance with the occurrence of the discount event.

2. The mobile computing device according to claim 1, wherein:
the computer program code includes an image recognition algorithm; and
in calculating the occurrence of the discount event, the computer program code controls the processor to determine the occurrence of the discount event with the image recognition algorithm having as input the video scene data.

3. The mobile computing device according to claim 2, wherein the image recognition algorithm comprises a color recognition technique.

4. The mobile computing device according to claim 2, wherein the image recognition algorithm comprises a shape recognition technique.

5. The mobile computing device according to claim 2, wherein the image recognition algorithm comprises a barcode recognition technique.

6. The mobile computing device according to claim 2, wherein the image recognition algorithm identifies a product.

7. The mobile computing device according to claim 2, wherein the image recognition algorithm identifies a store.

8. The mobile computing device according to claim 1, wherein:
the mobile computing device further comprises a location sensing means coupled to the processor and sensing location data; and
in determining the occurrence of the discount event, the processor is controlled by the computer program code to determine the occurrence of the discount event in accordance with the location data.

9. The mobile computing device according to claim 1, wherein:
the mobile computing device further comprises a location sensor coupled to the processor and sensing location data; and
in determining the occurrence of the discount event, the processor is controlled by the computer program code to determine the occurrence of the discount event in accordance with the location data.

10. The mobile computing device according to claim 1, wherein:
the mobile computing device further comprises an orientation sensing means coupled to the processor and sensing orientation data; and
in determining the occurrence of the discount event, the processor is controlled by the computer program code to determine the occurrence of the discount event in accordance with the orientation data.

11. The mobile computing device according to claim 10, wherein the processor is controlled by the computer program code to determine a display location of the discount related item in accordance with the orientation data.

12. The mobile computing device according to claim 1, wherein:
the mobile computing device further comprises an orientation sensor coupled to the processor and sensing orientation data; and
in determining the occurrence of the discount event, the processor is controlled by the computer program code to determine the occurrence of the discount event in accordance with the orientation data.
